(19) United States
(12) Patent Application Publication
(10) Pub. No.: US 2005/0272604 A1
(43) Pub. Date: Dec. 8, 2005

(54) Heat-sensitive recording material

(75) Inventors: Toshiyuki Watanabe, Shizuoka-ken (JP); Hiroyuki Kitaoka, Kanagawa (JP); Tomoki Nakamura, Shizuoka-ken (JP); Kazumori Minami, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/132,454

(22) Filed: May 19, 2005

(30) Foreign Application Priority Data
May 19, 2004 (JP) 2004-149818

(51) Int. Cl. B41M 5/30

(52) U.S. Cl. 503/226

(57) ABSTRACT

The present invention provides a heat-sensitive recording material in which heat-sensitive recording layers are provided on a support, the heat-sensitive recording layers each containing, as an emulsified dispersion, an electron-accepting compound which reacts with an electron-donating dye precursor to form color, or a coupler compound which reacts with a diazonium salt to form color. At least one layer of the heat-sensitive recording layers contains the emulsified dispersion having a volume average particle size of less than 0.18 μm. The volume average particle size of the emulsified dispersion is preferably less than 0.5 relative to the volume average particle size of the microcapsules encapsulating the electron-donating dye precursor or the diazonium salt.

### CROSS-REFERENCE TO RELATED APPLICATION

This application claims priority under 35 USC 119 from Japanese Patent Application No. 2004-149818, the disclosure of which is incorporated by reference herein.

### BACKGROUND OF THE INVENTION

1. Field of the Invention

The present invention relates to a heat-sensitive recording material, and particularly to a multicolor heat-sensitive recording material having a high coloring density and excellent color reproducibility.

2. Description of the Related Art

Recently, a heat-sensitive recording process which allows recording of an image by applying heat using a thermal head or the like, has been widely used because recording apparatuses for heat-sensitive recording are compact and simple, highly reliable, and require no maintenance. Especially in recent years, high-performance apparatuses designed to obtain a high image quality, improve storage stability, and the like, have been developed. As heat-sensitive recording materials used therein, those materials which utilize a reaction between an electron-donating colorless dye and an electron-accepting compound that forms the color of the dye, those materials which utilize a reaction between a diazonium salt compound and a coupler that forms the color of the compound, and the like, are well known.

Recently, multicolor heat-sensitive recording materials have made remarkable progress, and heat-sensitive recording materials in which plural types of color forming layers are stacked in combination make it possible to obtain multiple colors by forming color for each layer using heat. The multicolor heat-sensitive recording materials having such structures each utilize photodecomposition of a diazonium salt or the like, and fix an image by irradiating light thereon after formation of the image, thereby making it possible to improve stability of the image. However, it is extremely problematic to achieve further improvement in the color forming properties of the above-described multicolor heat-sensitive recording materials.

In order that a heat-sensitive recording material may obtain a sharp image having a sufficiently high optical density, the amount of a coupler compound or an electron-accepting compound used for coating needs to be increased as compared with that of an electron-donating dye precursor or a diazonium salt compound. In such a case, however, surface glossiness is deteriorated, or the transmissivity of light required for optical fixing of a diazonium salt is lowered, with the result that the fixing rate tends to deteriorate. Further, unless the color forming property is sufficiently obtained, a color reproduction region becomes small and an image having a high sharpness cannot be obtained.

As strategies for solving the various problems described above, for example, the following methods have been proposed.

(1) A multicolor heat-sensitive recording material in which a heat-sensitive color forming layer, including a diazo compound and a coupler that reacts with the diazo compound to thereby form color, contains alkyl parahydroxybenzoate having 8 to 18 carbon atoms in the alkyl group (see, for example, Japanese Patent Application Laid-Open (JP-A) No. 05-000568).

(2) A heat-sensitive recording material in which a heat-sensitive recording layer contains an electron-donating colorless dye encapsulated in microcapsules, and a specific electron-accepting compound (see, for example, JP-A No. 08-282124).

(3) A heat-sensitive recording material in which a heat-sensitive color forming layer containing a specific oxidation-colored leuco dye and a diazo compound is formed (see, for example, JP-A No. 09-011633).

(4) A heat-sensitive recording material in which a heat-sensitive color forming layer is formed which contains composite fine particles including a diazo compound, and which also contains coupling components which react with the above fine particles upon heating to form color (see, for example, JP-A No. 10-166727).

(5) A multicolor heat-sensitive recording material in which a heat-sensitive recording layer is provided which contains one kind of a specific compound as an electron-accepting compound (see, for example, JP-A No. 2003-011518).

(6) A heat-sensitive recording material in which a heat-sensitive recording layer is provided which contains an emulsion encapsulating a coupler compound, which emulsion has an average particle size of 0.05 to 0.70 μm (see, for example, JP-A No. 2003-136839).

However, especially in multicolor heat-sensitive recording materials, a sufficiently high level in terms of color density and color reproducibility has not yet been achieved, and further improvements therein are required.

Accordingly, an object of the present invention is to provide a heat-sensitive recording material in which a heat-sensitive recording layer is provided which contains, as an emulsified dispersion, an electron-accepting compound that reacts with an electron-donating dye precursor to form color, or a coupler compound that reacts with a diazonium salt to form color, which heat-sensitive recording material has a high color density and excellent color reproducibility.

### SUMMARY OF THE INVENTION

In view of the above-described circumstances, the inventors of the present invention studied earnestly, and found that the above-described object can be achieved by controlling a volume average particle size of an electron-accepting compound or a coupler compound, which is contained, as an emulsified dispersion, in a heat-sensitive recording layer, thereby completing the present invention.

That is, the present invention provides a heat-sensitive recording material described below.

A first aspect of the present invention is a heat-sensitive recording material in which heat-sensitive recording layers are provided on a support, the heat-sensitive recording layers each containing, as an emulsified dispersion, an electron-accepting compound which reacts with an electron-donating dye precursor to form color, or a coupler compound which reacts with a diazonium salt to form color, wherein at least one layer of the heat-sensitive recording layers contains the emulsified dispersion having a volume average particle size of less than 0.18 μm.

According to a second aspect of the present invention, in the heat-sensitive recording material of the first aspect, the volume average particle size is 0.16 μm or less.

According to a third aspect of the present invention, the heat-sensitive recording material of the first aspect comprises at least three heat-sensitive recording layers, which form colors of yellow, magenta and cyan, respectively, and at least one of the three layers contains the emulsified dispersion.

According to a fourth aspect of the present invention, the heat-sensitive recording material of the second aspect comprises at least three heat-sensitive recording layers, which form colors of yellow, magenta and cyan, respectively, and at least one of the three layers contains the emulsified dispersion.

According to a fifth aspect of the present invention, in the heat-sensitive recording material of the first aspect, at least one layer of the heat-sensitive recording layers contains an electron-donating dye precursor or diazonium salt encalsulated in microcapsules, and the volume average particle size of the emulsified dispersion is less than 0.5 relative to the volume average particle size of the microcapsules.

According to a sixth aspect of the present invention, in the heat-sensitive recording material of the second aspect, at least one layer of the heat-sensitive recording layers contains an electron-donating dye precursor or diazonium salt encalsulated in microcapsules, and the volume average particle size of the emulsified dispersion is less than 0.5 relative to the volume average particle size of the microcapsules.

According to a seventh aspect of the present invention, in the heat-sensitive recording material of the third aspect, at least one layer of the heat-sensitive recording layers contains an electron-donating dye precursor or diazonium salt encalsulated in microcapsules, and the volume average particle size of the emulsified dispersion is less than 0.5 relative to the volume average particle size of the microcapsules.

According to an eighth aspect of the present invention, in the heat-sensitive recording material of the fourth aspect, at least one layer of the heat-sensitive recording layers contains an electron-donating dye precursor or diazonium salt encalsulated in microcapsules, and the volume average particle size of the emulsified dispersion is less than 0.5 relative to the volume average particle size of the microcapsules.

Since the heat-sensitive recording material of the present invention is formed as described above, a (multicolor) heat-sensitive recording material can be provided in which a high-sharpness image having a high color density and excellent color reproducibility and causing no color blemish can be formed.

### DETAILED DESCRIPTION OF THE INVENTION

A heat-sensitive recording material of the present invention, in which heat-sensitive recording layers each containing, as an emulsified dispersion, an electron-accepting compound reacting with an electron-donating dye precursor to form color, or a coupler compound reacting with a diazonium salt to form color are provided on a support, is characterized in that at least one of the heat-sensitive recording layers contains the emulsified dispersion having a volume average particle size of less than 18 μm.

Next, the heat-sensitive recording material of the present invention will be described in detail.

At least one layer of the heat-sensitive recording layers of the present invention contains, as color forming components, an electron-donating dye precursor and an electron-accepting compound reacting with the electron-donating dye precursor to form color, or a diazonium salt and a coupler compound reacting with the diazonuim salt to form color. The heat-sensitive recording layer can also contain, in addition to these color forming components, a binder, oil components, basic material, other additives and the like according to the purposes and if necessary.

First, the color forming components to be used in the present invention will be described in detail.

[Diazonium Salt Compounds]

The diazonium salt compounds used in the heat-sensitive recording layer of the present invention includes those compounds represented by the following formula (1):
Ar—N₂⁺X⁻ (1)
wherein Ar represents an aromatic moiety, and X⁻ represents an acid anion.

The above-described diazonium salt compound is a compound that forms color upon heating and causing a coupling reaction with the coupler described below, and decomposes by light. The maximum absorption wavelength of this compound can be controlled by varying the position or type of substituent groups on the Ar moiety.

Suitable examples of salt-forming diazonium compounds include 4-(p-tolylthio)-2,5-dibutoxy benzene diazonium, 4-(4-chlorophenylthio)-2,5-dibutoxy benzene diazonium, 4-(N,N-dimethylamino)benzene diazonium, 4-(N,N-diethylamino)benzene diazonium, 4-(N,N-dipropylamino)benzene diazonium, 4-(N-methyl-N-benzylamino)benzene diazonium, 4-(N,N-dibenzylamino)benzene diazonium, 4-(N-ethyl-N-hydroxyethylamino)benzene diazonium, 4-(N,N-diethylamino)-3-methoxy benzene diazonium, 4-(N,N-dimethylamino)-2-methoxy benzene diazonium, 4-(N-benzoylamino)-2,5-diethoxybenzene diazonium, 4-morpholino-2,5-dibutoxybenzene diazonium, 4-anilinobenzene diazonium, 4-[N-(4-methoxybenzoyl)amino]-2,5-diethoxy benzene diazonium, 4-pyrrolidino-3-ethyl benzene diazonium, 4-[N-(1-methyl-2-(4-methoxyphenoxy)ethyl)-N-hexylamino]-2-hexyloxy benzene diazonium, 4-[N-(2-(4-methoxyphenoxy)ethyl)-N-hexylamino]-2-hexyloxy benzene diazonium, 2-(1-ethylpropyloxy)-4-[di-(di-n-butylaminocarbonylmethyl)amino]benzene diazonium, 2-benzylsulfonyl-4-[N-methyl-N-(2-octanoyloxyethyl)] aminobenzene diazonium, and the like.

The maximum absorption wavelength λₘₐₓ of the diazonium salt according to the present invention is preferably 450 nm or less, more preferably 290 to 440 nm. When the λₘₐₓ is specified within this range, shelf stability, image-fixing properties when used in combination with the coupler described below, such as image storability, and the hue forming a cyan color can be improved.

It is desirable that the diazonium salt of the present invention contains 12 or more carbon atoms and preferably has 1% or less solubility in water and 5% or more solubility in ethyl acetate.

The diazonium salt compounds may be used alone or in combination thereof depending on the purposes of adjusting the hue, and the like.

Among the diazonium salts described above, the diazonium salt compounds represented by the following structural formulae (1) to (3) are more preferable in respect of the hue exhibited by a pigment, image storability, and image fixation.

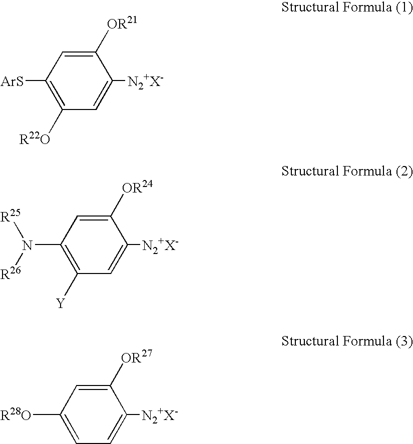

In the above structural formula (1), Ar represents a substituted or unsubstituted aryl group.

The aryl group represented by Ar is preferably an aryl group containing 6 to 30 carbon atoms, and examples thereof include a phenyl group, 2-methylphenyl group, 2-chlorophenyl group, 2-methoxyphenyl group, 2-butoxyphenyl group, 2-(2-ethylhexyloxy)phenyl group, 2-octyloxyphenyl group, 3-(2,4-di-t-pentylphenoxyethoxy)phenyl group, 4-chlorophenyl group, 2,5-dichlorophenyl group, 2,4,6-trimethylphenyl group, 3-chlorophenyl group, 3-methylphenyl group, 3-methoxyphenyl group, 3-butoxyphenyl group, 3-cyanophenyl group, 3-(2-ethylhexyloxy)phenyl group, 3,4-dichlorophenyl group, 3,5-dichlorophenyl group, 3,4-dimethoxyphenyl group, 3-(dibutylaminocarbonylmethoxy)phenyl group, 4-cyanophenyl group, 4-methylphenyl group, 4-methoxyphenyl group, 4-butoxyphenyl group, 4-(2-ethylhexyloxy)phenyl group, 4-benzylphenyl group, 4-aminosulfonylphenyl group, 4-N,N-dibutylaminosulfonyl phenyl group, 4-ethoxycarbonyl phenyl group, 4-(2-ethylhexylcarbonyl)phenyl group, 4-fluorophenyl group, 3-acetylphenyl group, 2-acetylaminophenyl group, 4-(4-chlorophenylthio)phenyl group, 4-(4-methylphenyl)thio-2,5-butoxyphenyl group, 4-(N-benzyl-N-methylamino)-2-dodecyloxycarbonyl phenyl group, and the like. However, preferred examples are not limited thereto in the present invention.

Further, these groups may be further substituted with an alkyl group, alkoxy group, aryl group, aryloxy group, arylthio group, acyl group, alkoxycarbonyl group, carbamoyl group, carbamide group, sulfonyl group, sulfamoyl group, sulfonamide group, ureido group, amino group, alkyloxy group, alkylthio group, substituted phenyl group, cyano group, substituted amino group, halogen atom, heterocyclic group, and the like. These substituents may be further substituted.

In the structural formula (1), R²¹ and R²² each independently represent a substituted or unsubstituted alkyl group or a substituted or unsubstituted aryl group. R²¹ and R²² may be the same or different from each other.

An alkyl group represented by R²¹ or R²² above is preferably an alkyl group containing 1 to 18 carbon atoms. Examples thereof include a methyl group, trifluoromethyl group, ethyl group, propyl group, isopropyl group, butyl group, sec-butyl group, t-butyl group, pentyl group, isopentyl group, cyclopentyl group, hexyl group, cyclohexyl group, octyl group, t-octyl group, 2-ethylhexyl group, nonyl group, octadecyl group, benzyl group, 4-methoxybenzyl group, triphenyl methyl group, ethoxycarbonyl methyl group, butoxycarbonyl methyl group, 2-ethylhexyloxycarbonyl methyl group, 2′,4′-diisopentylphenyloxymethyl group, 2′,4′-di-t-butylphenyloxymethyl group, dibenzylaminocarbonyl methyl group, 2,4-di-t-aminophenyloxypropyl group, ethoxycarbonyl propyl group, 1-(2′,4′-di-t-aminophenyloxy)propyl group, acetylaminoethyl group, 2-(N,N-dimethylamino)ethyl group, 2-(N,N-diethylamino)propyl group, methanesulfonylaminopropyl group, acetylaminoethyl group, 2-(N,N-dimethylamino)ethyl group, 2-(N,N-diethylamino)propyl group, and the like.

The aryl group represented by R²¹ and R²² above is preferably an aryl group containing 6 to 30 carbon atoms. Examples thereof include a phenyl group, 2-methylphenyl group, 2-chlorophenyl group, 2-methoxyphenyl group, 2-butoxyphenyl group,
2-(2-ethylhexyloxy)phenyl group, 2-octyloxyphenyl group,
3-(2,4-di-t-pentylphenoxyethoxy)phenyl group, 4-chlorophenyl group, 2,5-dichlorophenyl group, 2,4,6-trimethylphenyl group,
3-chlorophenyl group, 3-methylphenyl group, 3-methoxyphenyl group, 3-butoxyphenyl group, 3-cyanophenyl group,
3-(2-ethylhexyloxy)phenyl group, 3,4-dichlorophenyl group,
3,5-dichlorophenyl group, 3,4-dimethoxyphenyl group,
3-(dibutylaminocarbonylmethoxy)phenyl group, 4-cyanophenyl group, 4-methylphenyl group, 4-methoxyphenyl group,
4-butoxyphenyl group, 4-(2-ethylhexyloxy)phenyl group,
4-benzylphenyl group, 4-aminosulfonylphenyl group,
4-N,N-dibutylaminosulfonyl phenyl group, 4-ethoxycarbonyl phenyl group, 4-(2-ethylhexylcarbonyl)phenyl group, 4-fluorophenyl group, 3-acetylphenyl group, 2-acetylaminophenyl group,
4-(4-chlorophenylthio)phenyl group, 4-(4-methylphenyl)thio-2,5-butoxyphenyl group, 4-(N-benzyl-N-methylamino)-2-dodecyloxycarbonyl phenyl group, and the like. However, specific examples are not limited thereto.

The above-described alkyl group and aryl group each may be further substituted with an alkoxy group, alkoxycarbonyl group, alkylsulfonyl group, substituted amide group, aryl group, aryloxy group, alkyloxy group, alkylthio group, substituted phenyl group, cyano group, substituted amino group, halogen atom, heterocyclic group, and the like. These substituents may be further substituted.

In the structural formula (2), R²⁴, R²⁵ and R²⁶ each independently represent a substituted or unsubstituted alkyl group, or a substituted or unsubstituted aryl group, and R²⁴, R²⁵ and R²⁶ may be the same or different.

The alkyl group represented by R²⁴, R²⁵ and R²⁶ above is preferably an alkyl group containing 1 to 18 carbon atoms. Examples thereof include the alkyl groups represented by R²¹ and R²² in the structural formula (1), and 1-methyl-2-(4-methoxyphenoxy)ethyl group, di-n-butylaminocarbonyl methyl group, di-n-octylaminocarbonyl methyl group, and the like.

The aryl group represented by R²⁴, R²⁵ and R²⁶ above has the same meaning as the aryl group represented by R²¹ and R²² in the structural formula (1) above. However, the aryl group is not limited thereto.

These alkyl groups and aryl groups may be further substituted with an alkyl group, alkoxy group, aryl group, aryloxy group, arylthio group, acyl group, alkoxycarbonyl group, carbamoyl group, carboamido group, sulfonyl group, sulfamoyl group, sulfonamido group, ureido group, amino group, alkyloxy group, alkylthio group, substituted phenyl group, cyano group, substituted amino group, halogen atom, heterocyclic group, and the like. These substituents may be further substituted with other groups.

In the structural formula (2), Y represents a hydrogen atom or OR²³ group, wherein R²³ represents a substituted or unsubstituted alkyl group or a substituted or unsubstituted aryl group. For controlling the hue, it is preferable that Y is a hydrogen atom or an alkyloxy group wherein R²³ is an alkyl group.

The alkyl group represented by R²³ above has the same meaning as the alkyl group represented by R²¹ and R²² in the structural formula (1) above. However, the aryl group is not limited thereto.

The aryl group represented by R²³ above has the same meaning as the aryl group represented by R²¹ and R²² in the structural formula (1) above. However, the aryl group is not limited thereto.

These alkyl groups and aryl groups may be further substituted with an alkyl group, alkoxy group, aryl group, aryloxy group, arylthio group, acyl group, alkoxycarbonyl group, carbamoyl group, carboamido group, sulfonyl group, sulfamoyl group, sulfonamido group, ureido group, amino group, alkyloxy group, alkylthio group, substituted phenyl group, cyano group, substituted amino group, halogen atom, heterocyclic group, and the like. These substituents may be further substituted with other groups.

In the structural formula (3) above, R²⁷ and R²⁸ each independently represent a substituted or unsubstituted alkyl group or a substituted or unsubstituted aryl group, and R²⁷ and R²⁸ may be the same or different.

The alkyl group represented by R²⁷ and R²⁸ above has the same meaning as the alkyl group represented by R²¹ and R²² in the structural formula (1) above. However, the alkyl group is not limited thereto.

The aryl group represented by R²⁷ and R²⁸ above has the same meaning as the aryl group represented by R²¹ and R²² in the structural formula (1) above. However, the aryl group is not limited thereto.

These alkyl groups and aryl groups may be further substituted with an alkyl group, alkoxy group, aryl group, aryloxy group, arylthio group, acyl group, alkoxycarbonyl group, carbamoyl group, carboamido group, sulfonyl group, sulfamoyl group, sulfonamido group, ureido group, amino group, alkyloxy group, alkylthio group, substituted phenyl group, cyano group, substituted amino group, halogen atom, heterocyclic group, and the like. These substituents may be further substituted with other groups.

In the structural formulae (1) to (3) shown above, X⁻ represents an acid anion, and examples of acid anions include polyfluoroalkyl carboxylic acid containing 1 to 9 carbon atoms, polyfluoroalkyl sulfonic acid containing 1 to 9 carbon atoms, boron tetrafluoride, tetraphenyl boron, hexafluorophosphoric acid, aromatic carboxylic acid, aromatic sulfonic acid, and the like. In particular, hexafluorophosphoric acid is preferable in respect of crystallizability.

Examples of the diazonium salt compounds represented by the structural formulae (1) to (3) above are shown below, but are not limited thereto.

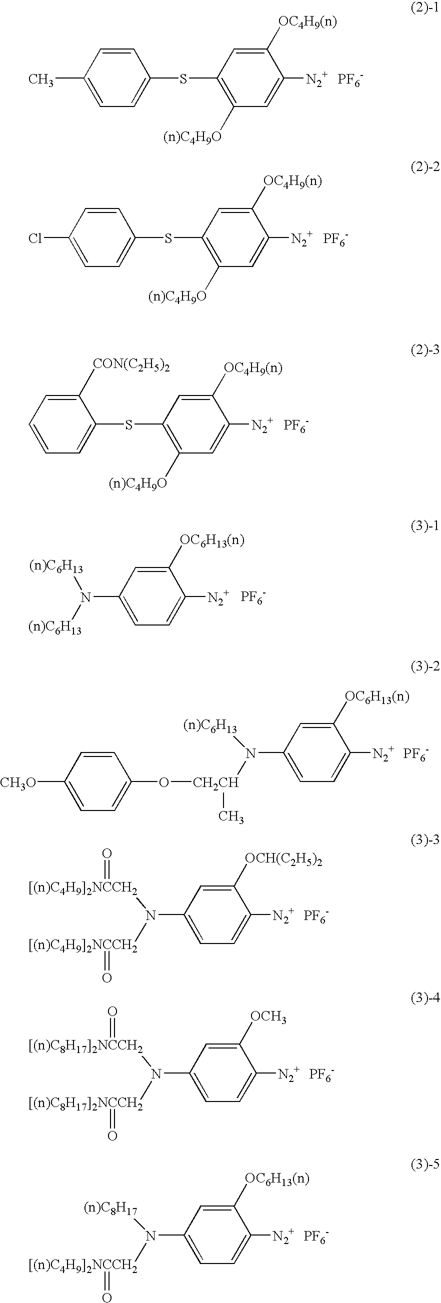

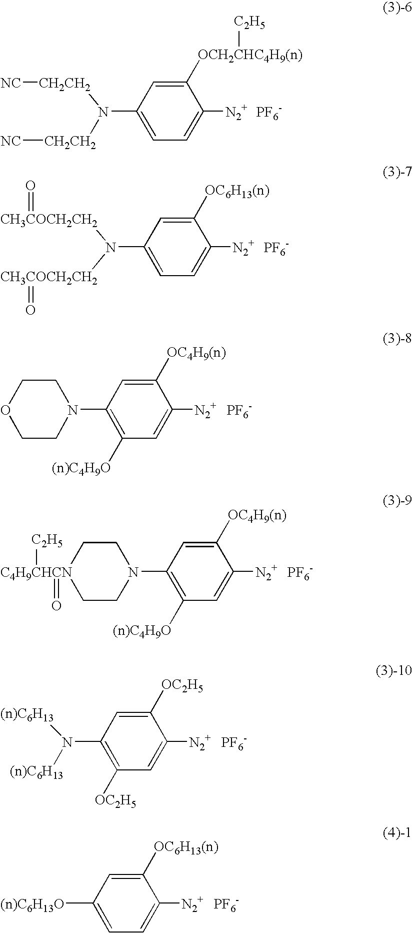

The diazonium salt compounds represented by the structural formulae (1) to (3) above may be used alone or in combination thereof. Depending on various purposes such as the hue control, and the like, the diazonium salt compounds represented by the structural formulae (1) to (3) may be used in combination with other existing diazonium salt compounds.

The amount of the diazonium salt compound applied for coating in the present invention is preferably 0.05 to 2 g/m², more preferably 0.1 to 1 g/m², in the heat-sensitive recording layer. When its content is specified within this range, sufficient color density is obtained while the coating suitability of the coating solution can be improved.

[Coupler Compounds]

The coupler compounds which can form color by undergoing a coupling reaction with the diazonium salt compound to form a coloring matter may be any compound capable of coupling with the diazonium salt compound to form a coloring matter in a basic atmosphere and/or a neutral atmosphere.

A so-called tetraequivalent coupler used in silver halide photographic photosensitive materials can be used as the coupler in the present invention and selected suitably so as to satisfy purposes such as obtaining suitable hues. For example, mention can be made of a so-called active methylene compound having a methylene group adjacent to a carbonyl group, phenol derivatives, naphthol derivatives, and the like.

As the coupler compounds used in the present invention, the compounds represented by formula (2) below or tautomers thereof are particularly preferable.
E¹-CH₂-E² (2)
wherein E¹ and E² may be the same or different and each independently represents an electron attractive group.

The electron attractive group refers to a substituent group whose Hammett's σ value is positive, and examples thereof include acyl groups such as an acetyl group, propionyl group, pivaloyl group, chloroacetyl group, trichloroacetyl group, trifluoroacetyl group, 1-methylcyclopropyl carbonyl group, 1-ethylcyclopropyl carbonyl group, 1-benzylcyclopropyl carbonyl group, benzoyl group, 4-methoxybenzoyl group and thenoyl group, alkoxycarbonyl groups such as methoxycarbonyl group, ethoxycarbonyl group, 2-methoxyethoxycarbonyl group and 4-methoxyphenoxycarbonyl group, carbamoyl groups such as carbamoyl group, N,N-dimethylcarbamoyl group, N,N-diethylcarbamoyl group, N-phenylcarbamoyl group,

N-[2,4-bis(pentyloxy)phenyl] carbamoyl group, N-[2,4-bis(octyloxy)phenyl] carbamoyl group or morpholinocarbonyl group, alkylsulfonyl groups or arylsulfonyl groups such as a methanesulfonyl group, benzenesulfonyl group or toluenesulfonyl group, phosphono groups such as a diethylphosphono group, and heterocyclic groups such as a benzoxazole-2-yl group, benzothiazole-2-yl group, 3,4-dihydroquinazoline-4-one-2-yl group, 3,4-dihydroquinazoline-4-sulfone-2-yl group, as well as nitro group, imino group, or cyano group.

The above E¹ and E² groups may be bound to each other to form a ring. The ring formed by E¹ and E² is preferably a 5- or 6-membered carbon ring or heterocyclic group.

Examples of couplers include resorcin, phloroglucin, 2,3-dihydroxynaphthalene, sodium 2,3-dihydroxynaphthalene-6-sulfonate, 1-hydroxy-2-naphthoic acid morpholinopropylamide, sodium 2-hydroxy-3-naphthalene sulfonate, 2-hydroxy-3-naphthalene sulfonic acid anilide, 2-hydroxy-3-naphthalene sulfonic acid morpholinopropylamide, 2-hydroxy-3-naphthalene sulfonic acid-2-ethylhexyloxy propylamide, 2-hydroxy-3-naphthalene sulfonic acid-2-ethylhexylamide, 5-acetamide-1-naphthol, sodium 1-hydroxy-8-acetamide naphthalene-3,6-disulfonate, 1-hydroxy-8-acetamide naphthalene-3,6-disulfonic acid dianilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexane dione, 1,3-cyclopentane dione, 5-(2-n-tetradecyloxyphenyl)-1,3-cyclohexane dione, 5-phenyl-4-methoxycarbonyl-1,3-cyclohexane dione, 5-(2,5-di-n-octyloxyphenyl)-1,3-cyclohexane di one, N,N′-dicyclohexylbarbituric acid, N,N′-di-n-dodecylbarbituric acid, N-n-octyl-N′-n-octadecylbarbituric acid, N-phenyl-N′-(2,5-di-n-octyloxyphenyl)barbituric acid, N,N′-bis(octadecyloxycarbonylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamide-5-pyrazolone, 6-hydroxy-4-methyl-3-cyano-1-(2-ethylhexyl)-2-pyridone, 2,4-bis-(benzoylacetamide)toluene, 1,3-bis-(pivaloylacetamidemethyl) benzene, benzoyl acetonitrile, thenoyl acetonitrile, acetacetanilide, benzoylacetanilide, pivaloyl acetanilide, 2-chloro-5-(N-n-butylsulfamoyl)-1-pivaloyl acetamide benzene, 1-(2-ethylhexyloxypropyl)-3-cyano-4-methyl-6-hydroxy-1,2-dihydropyridine-2-one, 1-(dodecyloxypropyl)-3-acetyl-4-methyl-6-hydroxy-1,2-dihydropyridine-2-one, 1-(4-n-octyloxyphenyl)-3-tert-butyl-5-aminopyrazol, and the like.

These coupler compounds are described in detail in JP-A Nos. 4-201483, 7-223367, 7-223368, 7-323660, 7-125446, 7-096671, 7-223367, 7-223368, 9-156229, 9-216468, 9-216469, 9-203472, 9-319025, 10-035113, 10-193801 and 10-265532.

Examples of the couplers represented by formula (3) above are shown below, but are not limited thereto.

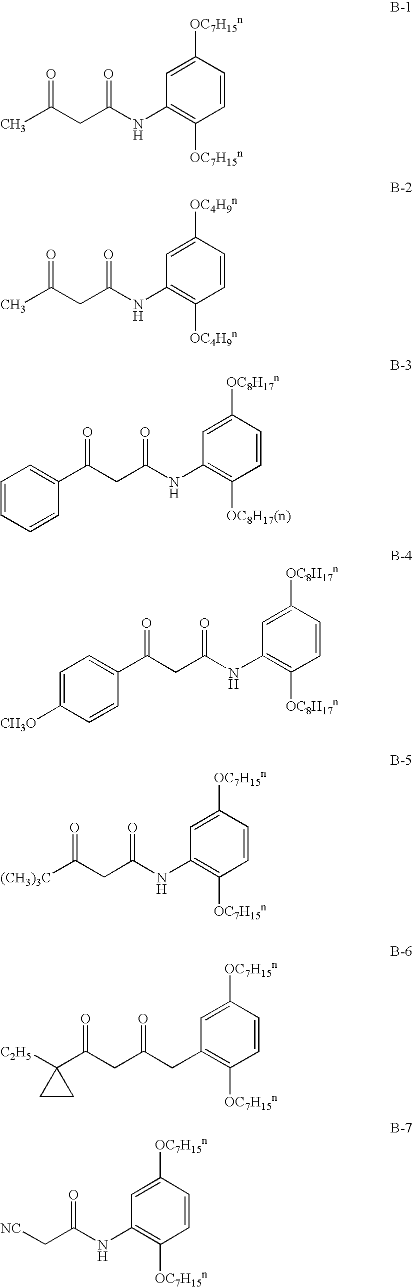

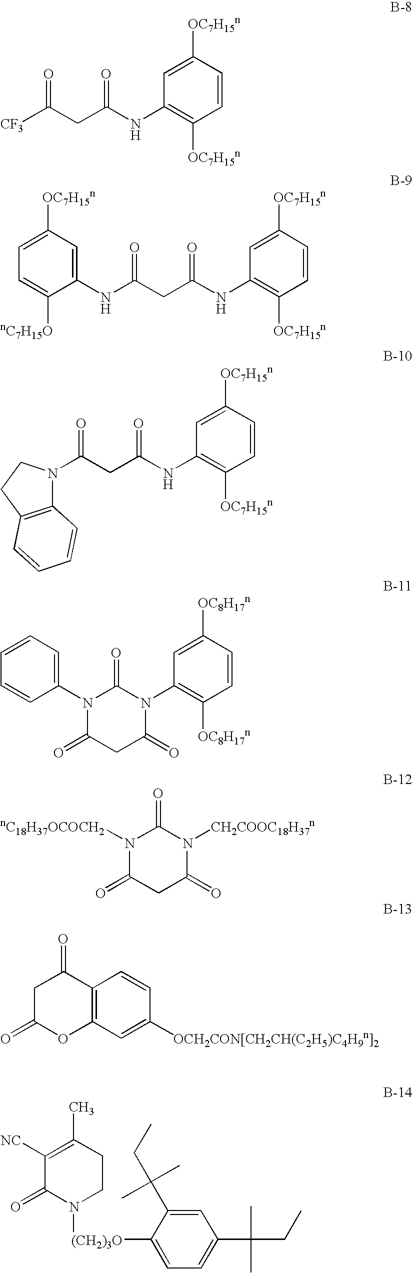

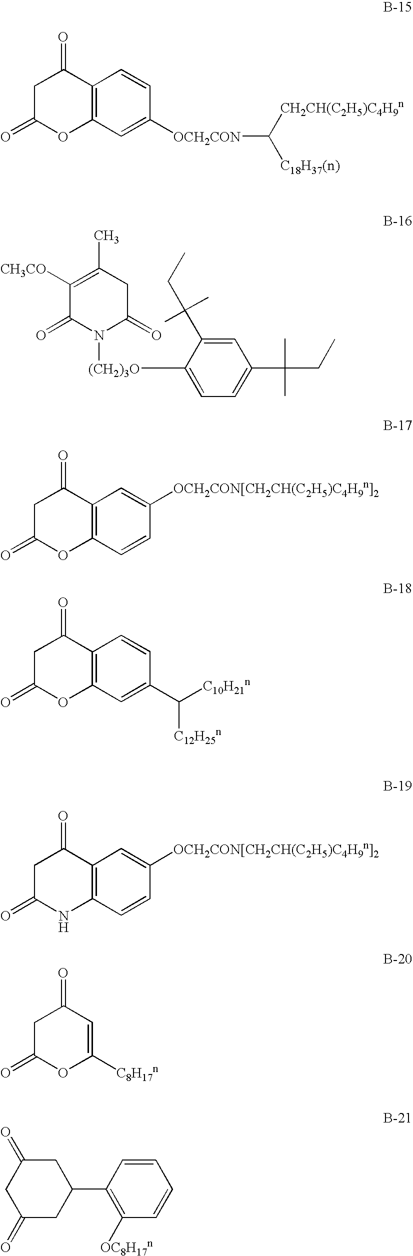

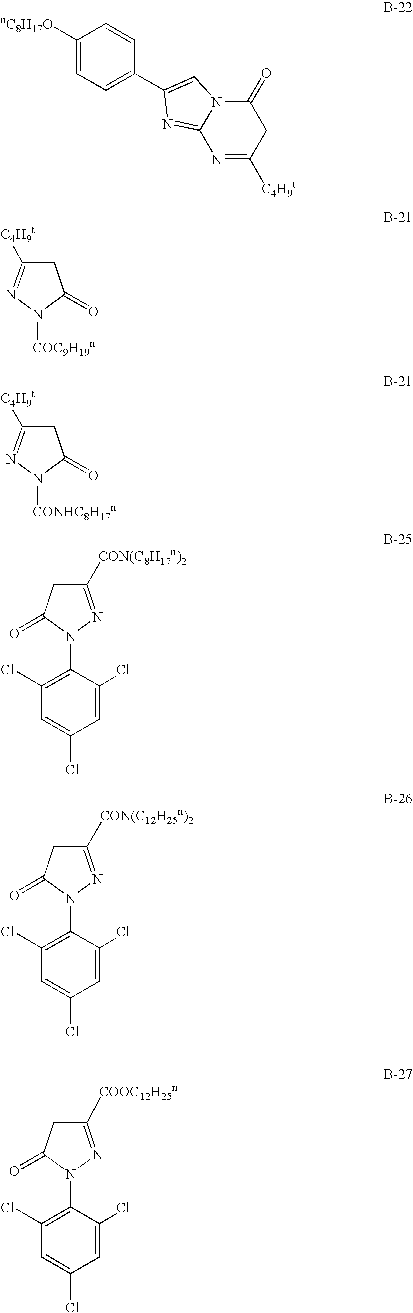

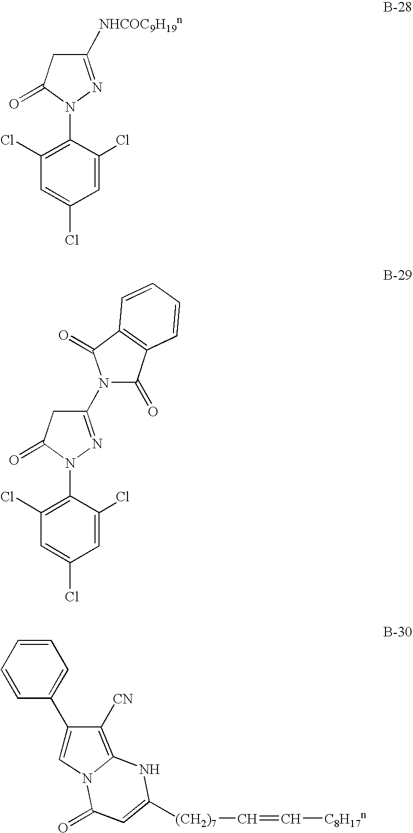

In the present invention, the content of the coupler in the heat-sensitive recording layer is preferably 0.1 to 30 parts by mass relative to 1 part by mass of the diazonium salt compound.

[Electron-Donating Dye Precursor]

In the heat-sensitive recording material of the present invention, it is possible to use not only the diazonium salt compound and the coupler (diazo-type color forming agent) but also a combination of an electron-donating dye precursor and an electron-accepting compound (leuco-type color forming agent). For example, in the heat-sensitive recording material having a plurality of heat-sensitive recording layers on the support, at least one layer may be formed as a layer containing a leuco-type color forming agent.

Examples of electron-donating dye precursors include, e.g., triaryl methane type compounds, diphenyl methane type compounds, thiazine type compounds, xanthene type compounds, spiropyran type compounds, and the like. In particular, triaryl methane type compounds and xanthene type compounds are preferable in respect of high color density.

Specifically, there can be exemplified the following compounds, such as 3,3-bis (p-dimethylaminophenyl)-6-dimethylaminophthalide (i.e., crystal violet lactone), 3,3-bis (p-dimethylamino)phthalide, 3-(p-dimethylaminophenyl)-3-(1,3-dimethylindole-3-yl)phthalide, 3-(p-dimethylaminophenyl)-3-(2-methylindole-3-yl)phthalide, 3-(o-methyl-p-dimethylaminophenyl)-3-(2-methylindole-3-yl)phthalide, 4,4′-bis (dimethylamino)benzhydrin benzyl ether, N-halophenyl leuco-auramine, N-2,4,5-trichlorophenyl leuco-auramine, rhodamine-B-anilinolactam, rhodamine(p-nitroanilino)lactam, rhodamine-B-(p-chloroanilino)lactam, 2-benzylamino-6-diethylaminofluoran, 2-anilino-6-diethylaminofluoran, 2-anilino-3-methyl-6-diethyl aminofluoran, 2-anilino-3-methyl-6-cyclohexyl methylaminofluoran, 2-anilino-3-methyl-6-isoamylethylaminofluoran, 2-(o-chloroanilino)-6-diethylaminofluoran, 2-octylamino-6-diethylaminofluoran, 2-ethoxyethylamino-3-chloro-2-diethylaminofluoran, 2-anilino-3-chloro-6-diethylaminofluoran, benzoyl leucomethylene blue, p-nitrobenzyl leucomethylene blue, 3-methyl-spiro-dinaphthopyran, 3-ethyl-spiro-dinaphthopyran, 3,3′-dichloro-spiro-dinaphthopyran, 3-benzylspirodinaphthopyran, 3-propyl-spiro-dibenzopyran, and the like.

In the present invention, the amount of the electron-donating dye precursor applied for coating is preferably 0.1 to 1 g/m² in the heat-sensitive recording layer for the same reason for the above-described diazonium salt compound.

[Electron-Accepting Compounds]

Examples of electron-accepting compounds used in the present invention include phenol derivatives, salicylic acid derivatives, hydroxybenzoic acid ester, and the like. In particular, bisphenols and hydroxybenzoic acid esters are preferable.

Specifically, there can be exemplified the following compounds, such as 2,2-bis(p-hydroxyphenyl)propane (i.e., bisphenol A), 4,4′-(p-phenylenediisopropylidene)diphenol (i.e., bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-3′,5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl)salicylic acid and multivalent metal salts thereof, 3,5-di(tert-butyl)salicylic acid and multivalent metal salts thereof, 3-α,α-dimethyl benzyl salicylic acid and multivalent metal salts thereof, butyl p-hydroxybenzoate, benzyl p-hydroxybenzoate, 2-ethylhexyl p-hydroxybenzoate, p-phenyl phenol, p-cumyl phenol, and the like.

The amount of the electron-accepting compound to be contained in the heat-sensitive recording layer is preferably 0.1 to 30 parts by mass relative to 1 part by mass of the electron-donating dye precursor.

(Other Components)

In the present invention, an organic base is preferably added for the purpose of accelerating the coupling reaction of the diazonium salt with the coupler. It is preferable that the organic base is contained in the heat-sensitive recording layer together with the diazonium salt compound and the coupler, and organic bases may be used alone or in combination.

Examples of organic bases include nitrogenous compounds such as tertiary amines, piperidines, piperazines, amidines, formamidines, pyridines, guanidines, morpholines, and the like. Further, such organic bases may be used as described in JP-B No. 52-46806, JP-A Nos. 62-70082, 57-169745, 60-94381, 57-123086, 58-1347901, 60-49991, JP-B Nos. 2-24916, 2-28479, JP-A Nos. 60-165288 and 57-185430.

Particularly preferable examples include piperazines such as N,N′-bis(3-phenoxy-2-hydroxypropyl)piperazine, N,N′-bis[3-(p-methylphenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis[3-(β-naphthoxy)-2-hydroxypropyl]piperazine, N-3-(β-naphthoxy)-2-hydroxypropyl-N′-methyl piperazine and 1,4-bis{[3-(N-methylpiperazino)-2-hydroxy]propyloxy}benzene, morpholines such as N-[3-(β-naphthoxy)-2-hydroxy]propylmorpholine, 1,4-bis(3-morpholino-2-hydroxy-propyloxy) benzene and 1,3-bis(3-morpholino-2-hydroxy-propyloxy) benzene, piperidines such as N-(3-phenoxy-2-hydroxypropyl)piperidine and N-dodecyl piperidine, and guanidines such as triphenyl guanidine, tricyclohexyl guanidine and dicyclohexyl phenyl guanidine.

When the organic base is contained as necessary, the amount of the organic base to be contained in the heat-sensitive recording layer is preferably 0.1 to 30 parts by mass relative to 1 part by mass of the diazonium salt compound.

In addition to the organic base, a sensitizer can also be added to the heat-sensitive recording layer for the purpose of facilitating a color forming reaction.

The sensitizer is a material which serves to increase color density during thermal recording or to decrease the minimum coloring temperature, and also allows lowering of the melting point of the coupler, the organic base or the diazonium salt compound or lowering of the softening point of the capsule wall in order to facilitate the reaction among the diazonium salt compound, the organic base, the coupler and the like.

Preferable examples are low melting point organic compounds suitably having an aromatic group and a polar group in the molecule, and include benzyl p-benzyloxybenzoate, α-naphthyl benzyl ether, β-naphthyl benzyl ether, phenyl β-naphthoate, phenyl α-hydroxy-α-naphthoate, p-naphthol-(p-chlorobenzyl) ether, 1,4-butanediol phenyl ether, 1,4-butanediol-p-methyl phenyl ether, 1,4-butanediol-p-ethyl phenyl ether, 1,4-butanediol-m-methyl phenyl ether, 1-phenoxy-2-(p-tolyloxy)ethane, 1-phenoxy-2-(p-ethylphenoxy)ethane, 1-phenoxy-2-(p-chlorophenoxy)ethane and p-benzyl biphenyl.

The binders used in the heat-sensitive recording layer include known water-soluble polymer compounds, latexes, and the like.

Examples of water-soluble polymer compounds include methyl cellulose, carboxymethyl cellulose, hydroxyethyl cellulose, hydroxypropyl cellulose, starch derivatives, casein, gum arabic, gelatin, ethylene/maleic anhydride copolymers, styrene/maleic anhydride copolymers, polyvinyl alcohol, epichlorohydrin-modified polyamide, isobutylene/maleic anhydride salicylic acid copolymers, polyacrylic acid and polyacrylic acid amide, as well as modified products thereof. The latexes include styrene-butadiene rubber latex, methyl acrylate-butadiene rubber latex, vinyl acetate emulsion, and the like.

For the purpose of controlling hues, a pigment may also be contained in the heat-sensitive recording layer.

Known pigments, which may be organic or inorganic, can be used, and examples thereof include kaolin, calcined kaolin, talc, agalmatolite, diatomaceous earth, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, mica, microbaloon, urea-formalin fillers, polyester particles, cellulose fillers, and the like.

In order to improve the fastness of a colored images to light and heat or to reduce yellowing of an unprinted area (a non-image portion) due to light after fixation, the following known antioxidants are also preferably used.

The antioxidants include those described in European Patent Publication Nos. 223739, 309401, 309402, 310551, 310552 and 459416, German Patent Publication No. 3435443, JP-A Nos. 54-48535, 62-262047, 63-113536, 63-163351, 2-262654, 2-71262, 3-121449, 5-61166, 5-119449, and U.S. Pat. Nos. 4,814,262 and 4,980,275.

In the present invention, there is no particular limitation to the mode of using the above-described diazonium salt compounds, coupler compounds for color formation by causing a thermal reaction with the diazonium salt compound, additional components such as organic base and sensitizer, the electron-donating dye precursor, and the electron-accepting compound. Preferable modes include (1) a method using the above compounds in the form of a solid dispersion, (2) a method using the above compounds in the form of an emulsified dispersion, (3) a method using the above compounds in the form of a polymer dispersion, (4) a method using the above compounds in the form of a latex dispersion, and (5) a method utilizing the above compounds in the form of microcapsules. In particular, (5) the method utilizing the above compounds in the form of microcapsules is preferable from the viewpoint of shelf storage. Particularly in (a) a color forming system where the diazonium salt compound is allowed to react with the coupler, the mode of microencapsulating the diazonium salt compound is preferable, and in (b) a color forming system where the electron-donating dye precursor is allowed to react with the electron-accepting compound, the mode of microencapsulating the electron-donating dye precursor is preferable.

(Method of Producing the Microcapsules)

In order to improve the shelf stability of the heat-sensitive recording material of the present invention, it is preferred to encapsulate the diazonium salt compound and/or the electron-donating dye precursor in microcapsules.

As the method of microencapsulating the color forming components, known conventional methods can be used. A preferable method is an interfacial polymerization method wherein the diazonium salt compound (or the electron-donating dye precursor) as one color forming component is dissolved or dispersed in an organic solvent which is low in solubility or insoluble in water, and the resulting oil phase is mixed with a water phase containing the water-soluble polymer dissolved therein, then emulsified and dispersed by means of, e.g., a homogenizer followed by heating, whereby polymerization reaction occurs at the interface of the oil droplets to form a microcapsule wall encapsulating the polymer. The interfacial polymerization method allows formation of capsules having uniform particle diameter in a short time and production of the recording material excellent in shelf stability.

Examples of organic solvents include low-boiling co-solvents such as acetic acid ester, methylene chloride and cyclohexanone, and/or phosphoric acid ester, carboxylic acid esters such as phthalic acid ester, acrylic acid ester and methacrylic acid ester, fatty acid amides, alkylated biphenyl, alkylated terphenyl, alkylated naphthalene, diaryl ethane, chlorinated paraffin, alcohol type solvent, phenol type solvent, ether type solvent, monoolefin type solvent, epoxy type solvent, and the like.

Specific examples thereof include high-boiling solvents such as tricresyl phosphate, trioctyl phosphate, octyldiphenyl phosphate, tricyclohexyl phosphate, dibutyl phthalate, dioctyl phthalate, dilaurate phthalate, dicyclohexyl phthalate, butyl olefinate, diethylene glycol benzoate, dioctyl sebacate, dibutyl sebacate, dioctyl adipate, trioctyl trimellitate, acetyl triethyl citrate, octyl maleate, dibutyl maleate, isoamyl biphenyl, chlorinated paraffin, diisopropyl naphthalene, 1,1′-ditolyl ethane, 2,4-di-tert-amyl phenol, N,N-dibutyl-2-butoxy-5-tert-octyl aniline, 2-ethylhexyl hydroxybenzoate, and polyethylene glycol.

Among these, the alcohol type solvent, phosphate type solvent, carboxylate type solvent, alkylated biphenyl, alkylated terphenyl, alkylated naphthalene, and diaryl ethane are particularly preferable.

Further, antioxidants such as hindered phenol and hindered amine may be added to the high-boiling solvent. The high-boiling solvent is preferably a solvent particularly having unsaturated fatty acid, and examples include α-methyl styrene dimers. The α-methyl styrene dimers include, for example, “MSD100” produced by Mitsui Toatsu Chemicals, Inc.

Examples of water-soluble polymers include water-soluble polymers such as polyvinyl alcohol. Preferable examples include polyvinyl alcohol, silanol-modified polyvinyl alcohol, carboxy-modified polyvinyl alcohol, amino-modified polyvinyl alcohol, itaconic acid-modified polyvinyl alcohol, styrene/maleic anhydride copolymers, butadiene/maleic anhydride copolymers, ethylene/maleic anhydride copolymers, isobutylene/maleic anhydride copolymers, polyacrylamide, polystyrenesulfonic acid, polyvinyl pyrrolidone, ethylene/acrylic acid copolymers, gelatin, and the like. Among these, carboxy-modified polyvinyl alcohol is preferable.

The water-soluble polymer can be used in combination with a hydrophobic polymer emulsion or latex. The emulsion or latex includes styrene/butadiene copolymers, carboxy-modified styrene/butadiene copolymers and acrylonitrile/butadiene copolymers. If necessary, a known conventional surfactant or the like may be added.

The polymer materials constituting the microcapsule wall include, for example, polyurethane resin, polyurea resin, polyamide resin, polyester resin, polycarbonate resin, aminoaldehyde resin, melamine resin, polystyrene resin, styrene/acrylate copolymer resin, styrene/methacrylate copolymer resin, gelatin, polyvinyl alcohol, and the like. Among these, polyurethane/polyurea resin is particularly preferable.

For example, when polyurethane/polyurea resin is used as the capsule wall material, a microcapsule wall precursor such as polyvalent isocyanate is encapsulated and incorporated in an oil medium (oil phase) as a core material, while a second material (e.g., polyol, polyamine) which reacts with the microcapsule wall precursor to form a capsule wall is incorporated in the water water-soluble polymer solution (water phase), and after the oil phase is emulsified and dispersed in the water phase, the resultant emulsified dispersion is heated whereby polymerization reaction occurs at the interface of oil droplets to finally form a microcapsule wall.

Examples of the polyvalent isocyanate compounds are shown below. However, these are not intended to limit the present invention. Examples thereof include diisocyanates such as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-diphenylmethane-4,4′-diisocyanate, xylene-1,4-diisocyanate, 4,4′-diphenylpropane diisocyanate, trimethylene diisocyanate, hexamethylene diisocyanate, propylene-1,2-diisocyanate, butylene-1,2-diisocyanate, cyclohexylene-1,2-diisocyanate and cyclohexylene-1,4-diisocyanate, triisocyanates such as 4,4′,4″-triphenylmethane triisocyanate and toluene-2,4,6-triisocyanate, tetraisocyanates such as 4,4′-dimethylphenylmethane-2,2′,5,5′-tetraisocyanate, and isocyanate prepolymers such as an adduct of hexamethylene diisocyanate and trimethylol propane, an adduct of 2,4-tolylene diisocyanate and trimethylol propane, an adduct of xylylene diisocyanate and trimethylol propane, and an adduct of tolylene diisocyanate and hexane triol.

As necessary, these compounds may be used in combination thereof. Those compounds having 3 or more isocyanate groups in the molecule are particularly preferable.

In the method of forming microcapsules, the organic solvent for dissolving the coupler compound (or the electron-accepting compound), the organic base and other components such as sensitizer, and the microcapsule wall precursor and the second material reacting therewith is the same as the organic solvent described above.

The particle diameter of the microcapsules is preferably 0.1 to 1.0 μm, more preferably 0.2 to 0.7 μm.

(Method of Producing an Emulsified Dispersion)

In the recording material of the present invention, a heat-sensitive recording layer contains, as an emulsified dispersion, an electron-accepting compound, that is, a developer which reacts with the above-described electron-donating dye precursor to form color, or a coupler compound, that is, a coloring agent which reacts with a ziazonium salt to form color. The emulsified dispersion containing the electron-accepting compound or coupler compound, and the method for producing the same will be hereinafter described in detail.

The emulsified dispersion containing the electron-accepting compound or coupler compound, which is used in the present invention, can be easily obtained in such a manner that, for example, an electron-accepting compound or coupler compound is dissolved in a high-boiling organic solvent which is low in solubility or insoluble in water, and thereafter, mixed with a water polymeric solution (a water phase medium) containing, as a protective colloid, a surfactant and/or a water-soluble polymer, and then emulsified and dispersed by means of a high-speed disperser such as a homogenizer. In this case, a low-boiling solvent can be used as an auxiliary solvent if necessary. Alternatively, there can be also used a method in which the electron-accepting compound or coupler compound, and an organic base are independently emulsified and dispersed, and thereafter, mixed together and dissolved in a high-boiling organic solvent, and further emulsified and dispersed.

As described above, a volume average particle size of the emulsified dispersion containing the electron-accepting compound or coupler compound, which is used in the present invention, is defined so as to be less than 0.18 μm. The volume average particle size of the emulsified dispersion is preferably 0.16 μm or less from the aspect of further improving color density and color reproducibility. The lower limit value of the volume average particle size is not particularly set, but in general application of heat-sensitive recording material, it suffices that the volume average particle size of the emulsified dispersion be on the level of about 0.05 μm.

Further, in order to improve color density and color reproducibility, the volume average particle size of the emulsified dispersion containing the electron-accepting compound or coupler compound, which is used in the present invention, is preferably less than 0.5 relative to the volume average particle size of microcapsules for encapsulating the electron-donating dye precursor or diazonium salt. The ratio of the volume average particle size of the emulsified dispersion is preferably less than 0.40, most preferably less than 0.35, for the purpose of further improving color density and color reproducibility. The lower limit value of the ratio of the volume average particle size is not particularly set, but in general application of heat-sensitive recording material, it suffice that the lower limit be on the level of about 0.15.

In the description given herein, the above-mentioned term “volume average particle size” refers to those defined in “Power Technology Handbook” by K. Gotoh et al, second edition, Marcell Dekker Publications, 1997, pages 3 to 13. The above-described volume average particle size used in the present invention can be easily measured using, for example, Coulter LS Particle Size Meter (produced by Coulter Electronics Co., Ltd., Saint Pittsburgh, Fla., U.S.A.), or a particle size distribution measuring device (“LA-700” produced by Horiba Ltd.), which devices are both commercially available.

The above-described high-boiling organic solvent used for the emulsified dispersion of the present invention can be suitably selected from examples of high-boiling oil mentioned in JP-A No. 2-141279. Among them, esters are preferably used from the aspect of emulsion stability of an emulsified dispersion solution, and tricresyl phosphate is particularly preferable. The oil materials disclosed in the above publication can be used in combination, or can be used with other types of oil materials.

The surfactant to be added in the present invention is suitably selected from conventionally known anionic surfactants, nonionic surfactants and cationic surfactants.

Examples of the above-described surfactants include: anionic surfactants such as a fatty acid salt, an alkyl sulfate ester salt, alkyl benzene sulfonate, alkyl naphthalene sulfonate, dialkyl sulfosuccinate, alkyl phosphate ester salt, naphthalenesulfonate formaldehyde condensation and polyoxyethylene alkyl sulfate ester salt; nonionic surfactants such as polyoxyethylene alkyl ether, polyoxyethylene alkylallyl ether, polyoxyethylene fatty acid ester, sorbitan fatty acid ester, polyoxyethylene sorbitan fatty acid ester, polyoxyethylene alkylamine, glycerine fatty acid ester and oxyethylene/oxypropylene block copolymer; acetylene series polyoxyethylene oxide surfactants such as “SURFYNOLS” (produced by AirProducts & Chemicals); ampholytic surfactants such as N,N-dimethyl-N-alkylamine oxide (amine oxide type); those described in JP-A No. 59-157636 (pages 37 to 38); and those described in Research Disclosure No. 308119 (1989).

In the present invention, the anionic surfactants are preferably added from the aspect of stabilizing the particle size of the emulsified dispersion with time.

The above-described water-soluble polymer contained as a protective colloid can be suitably selected from well-known anionic polymers, nonionic polymers, and ampholytic polymers, and a water-soluble polymer having 5% or more solubility in water at the temperature suitable for emulsification is preferable. Specific examples thereof include polyvinyl alcohol and its modified product, polyacrylic acid amide or its derivatives, ethylene/vinyl-acetate copolymer, styrene/maleic-anhydride copolymer, ethylene/maleic-anhydride copolymer, isobutylene/maleic-anhydride copolymer, polyvinyl pyrrolidone, ethylene/acrylic-acid copolymer, vinyl-acetate/acrylic acid copolymer, cellulose derivatives such as carboxymethyl cellulose or methyl cellulose, casein, gelatin, starch derivatives, gum arabic, sodium alginate, and the like. Among them, polyvinyl alcohol, gelatin, and cellulose derivatives are particularly preferable.

Further, the mixing ratio of an oil phase liquid to a water phase liquid (oil phase mass/water phase mass) is preferably in the range of 0.02 to 0.6, and more preferably in the range of 0.1 to 0.4. If the mixing ratio is less than 0.02, the water phase is too much and the liquid becomes thin, thereby resulting in lacking in production suitability. To the contrary, if the mixing ratio is more than 0.6, the viscosity of the solution becomes too high and there is a fear that inconvenient handling or deteriorated stability of the coating solution may be caused. These cases are not preferable.

In the present invention, the volume average particle size of the emulsified dispersion can be controlled in the specific range by adjusting, for example, the mixing ratio between a water phase medium and an oil phase solution containing an electron-accepting compound or a coupler compound, the mixing temperature, the mixing time, the mixing (stirring) rate, the type and content of a low-boiling organic solvent and other additives in the oil phase solution, the type and content of water-soluble polymer, surfactant, or other additives in the water phase medium, the procedure for addition of materials, and the like. However, there are cases in which restrictions may be placed in the upper limits of effective amounts to be added, the mixing temperature, the stirring rate, the mixing time and the like, and therefore, it is desirable to suitably select these preferred ranges individually.

As the emulsion disperser used in the present invention, there can be used known ones such as simple stirring system using a stirrer or impeller, inline stirring system, mill system using a colloid mill or ultrasonic wave system. Further, a high-pressure emulsion disperser or a high-pressure homogenizer can also be used. The specific mechanism of the above-described high-pressure homogenizer is described in U.S. Pat. No. 4,533,254 or JP-A No. 6-47264. Examples of the commercially available system include “Gaulin homogenizer” (produced by A.P.V GAULIN INC.), “Micro-fluidizer” (produced by MICROFLUIDEX INC.) and “Ultimaizer” (produced by Sugino Machine).

A recently developed high pressure homogenizer as described in U.S. Pat. No. 5,720,551 having a mechanism for forming fine droplets in an ultrahigh pressure jet stream is particularly effective for emulsification and dispersion of colored fine particles in the present invention. “DeBEE 2000” (produced by BEE INTERNATIONAL LTD.) is one of the emulsion disperser that uses this ultrahigh pressure jet stream.

(Multicolor Heat-Sensitive Recording Material)

Hereinafter, specific structural modes of the multicolor recording material are described.

The heat-sensitive recording material of the present invention may be a single-color heat-sensitive recording material having one heat-sensitive recording layer on a support, or a multicolor heat-sensitive recording material having a plurality of single-color heat-sensitive recording layers laminated on a support. In each case, it is an essential requirement that a heat-sensitive recording layer containing the above-described emulsified dispersion be provided. The multicolor heat-sensitive recording material is preferably one wherein at least one of the heat-sensitive recording layers is a light-fixing type recording layer containing a diazonium salt compound and a coupler that reacts with the diazonium salt compound to form color.

Particularly, in the case of a heat-sensitive recording material comprising full-color heat-sensitive recording layers containing cyan, yellow and magenta, preferred is one wherein all the three layers on the support comprise a diazo type color developing agent, or the first heat-sensitive recording layer from the support comprises a leuco type color forming agent containing an electron-donating dye and an electron-accepting compound while the second and third heat-sensitive recording layers comprise a diazo type color forming agent.

For example, it may be constituted as shown in the modes (a) to (c):
that is, the recording material (a) wherein a light-fixing type recording layer (first recording layer (layer A)) containing a diazonium salt compound having the maximum absorption wavelength of 360±20 nm and a coupler reacting with the diazonium salt compound to form color, and another light-fixing type recording layer (second recording layer (layer B)) containing a diazonium salt compound having the maximum absorption wavelength of 400±20 nm and a coupler reacting with the diazonium salt compound to form color, are laminated in this order on a support, and additionally a light transmittance-adjusting layer and a protective layer are arranged as necessary above the layers;
the recording material (b) wherein a recording layer (first recording layer (layer A)) containing an electron-donating dye and an electron-accepting compound, a light-fixing type recording layer (second recording layer (layer B)) containing a diazonium salt compound having the maximum absorption wavelength of 360±20 nm and a coupler reacting with the diazonium salt compound to form color, and a light-fixing type recording layer (third recording layer (layer C)) containing a diazonium salt compound having the maximum absorption wavelength of 400±20 nm and a coupler reacting with the diazonium salt compound to form color are laminated in this order on a support, and additionally a light transmittance-adjusting layer and a protective layer are arranged as necessary above the layers; and the recording material (c) wherein a light-fixing type recording layer (first recording layer (layer A)) containing a diazonium salt compound having the maximum absorption wavelength of 340±20 nm and a coupler reacting with the diazonium salt compound to form color, a light-fixing type recording layer (second recording layer (layer B)) containing a diazonium salt compound having the maximum absorption wavelength of 360±20 nm and a coupler reacting with the diazonium salt compound to form color, and a light-fixing type recording layer (third recording layer (layer C)) containing a diazonium salt compound having the maximum absorption wavelength of 400±20 nm and a coupler reacting with the diazonium salt compound to form color are laminated in this order on a support, and further a light transmittance-adjusting layer and a protective layer are arranged as necessary above the layers.

The method of multicolor recording performed using the recording material (b) or (c) above is described below.

First, the third recording layer (layer C) is heated to cause color formation between the diazonium salt and the coupler contained in the layer. Then, a light of wavelength of 400±20 nm is irradiated and after light fixation by decomposing the unreacted diazonium salt compound in layer C, sufficient heat is applied to the second recording layer (layer B) to cause color formation between the diazonium salt compound and the coupler contained in the layer. The layer C is also simultaneously strongly heated, but the diazonium salt compound has previously been decomposed (light fixation) to lose its color forming ability, and thus layer C does not form color. Further, a light of wavelength of 360±20 nm is applied and after light fixation by decomposing the diazonium salt compound in layer B, sufficient heat is finally applied to the first recording layer (layer A) to form color. At this moment, strong heat is simultaneously applied to the recording layers of layers B and C, but the diazonium salt compound has already been decomposed to lose its color forming ability, and thus layers B and C do not form color.

The respective layers are arranged preferably such that the yellow color forming layer which is low in visibility is provided as the lowermost layer in order to reduce the influence of the rough surface of the support on image qualities to thereby improve image qualities.

If all the recording layers (layers A, B and C) contain diazo type compounds, it is necessary to effect photo-fixation of layers A and B after color formation, but it is not always necessary to effect photo-fixation of layer C in which image recording is conducted lastly. However, from the viewpoint of improving the storage stability of formed images, light-fixation is preferably conducted.

The light source used for light-fixation can be suitably selected from known light sources, and examples thereof include various fluorescent lamps, xenon lamps, mercury lamps, and the like. In particular, a light source whose emission spectrum almost corresponds to the absorption spectrum of the diazonium salt compound used in the recording material is preferably used to achieve highly efficient light-fixation.

In a preferable mode, the heat-sensitive recording material of the present invention has a light transmittance-adjusting layer and a protective layer, in addition to the one or more heat-sensitive recording layers on the support.

(Light Transmittance-Adjusting Layer)

The light transmittance-adjusting layer contains a UV absorber precursor, and before irradiation with a light of wavelength in the range necessary for fixation, the above precursor does not function as UV absorber and thus the light transmittance of the layer is high. When fixing the light-fixing type heat-sensitive recording layer, the light transmittance-adjusting layer permits not only visible lights but also a light of wavelength in the range necessary for fixation to sufficiently pass therethrough, and thus the fixation of the heat-sensitive recording layer is not adversely affected. This UV absorber precursor is preferably contained in the microcapsules.

The compounds contained in this light transmittance-adjusting layer include those described in JP-A No. 9-1928.

After irradiation of the heat-sensitive recording layer with a light of wavelength in the range necessary for fixation, the UV absorber precursor, upon undergoing optical or thermal reaction, comes to function as a UV absorber, which absorbs a majority of UV light of wavelengths in the range necessary for fixation, thus lowering the transmittance and improving the light resistance of the heat-sensitive recording material, while the transmittance of visible light is substantially unchanged because it has no effect of absorbing visible light.

At least one light transmittance-adjusting layer can be arranged in the heat-sensitive recording material, most preferably between the heat-sensitive recording layer and the outermost protective layer. Alternatively, the light transmittance-adjusting layer may be also adapted to serve as the protective layer. The characteristics of the light transmittance-adjusting layer can be arbitrarily selected depending on the characteristics of the heat-sensitive recording layers.

A coating solution for forming the light transmittance-adjusting layer (a coating solution for the light transmittance-adjusting layer) is prepared by mixing the respective components described above. The light transmittance-adjusting layer can be formed by applying the coating solution by known coating techniques using, for example, a bar coater, an air knife coater, a blade coater, or a curtain coater. The light transmittance-adjusting layer can be formed simultaneously with formation of the heat-sensitive recording layer, and the like. Alternatively, the coating solution for the heat-sensitive recording layer is first coated, and after the resultant heat-sensitive layer is dried, the light transmittance-adjusting layer may be formed above said layer.

(Protective Layer and Intermediate Layer)

The protective layer comprises, in addition to a binder, a pigment, a lubricant, a surfactant, a dispersant, a fluorescent brightener, a metal soap, a hardener, a UV absorber, a cross-linking agent, and the like.

Examples of the binder include polyvinyl alcohol, fully saponified polyvinyl alcohol, partially saponified polyvinyl alcohol, carboxy-modified polyvinyl alcohol, acetoacetyl-modified polyvinyl alcohol, diacetone-modified polyvinyl alcohol, silicon-modified polyvinyl alcohol, starch, oxidized starch, cation-modified polyvinyl alcohol, hydroxyethyl cellulose, methyl cellulose, carboxymethyl cellulose, gelatin, casein, gum arabic, and acrylate-based or vinyl acetate-based cationic latexes. Among them, polyvinyl alcohol and gelatin are preferable, and polyvinyl alcohol is more preferable. The polyvinyl alcohols herein includs modified polyvinyl alcohols. As the modified polyvinyl alcohol, carbonyl modified polyvinyl alcohol, carboxy modified polyvinyl alcohol, silanol modified polyvinyl alcohol, ethylene modified polyvinyl alcohol and the like are exemplified.

Examples of the pigment include inorganic pigments such as amorphous silica having an average particle size of about 0.1 to 5 μm, aluminum silicate, magnesium silicate, alumina gel, precipitated calcium carbonate light, calcium carbonate heavy, calcium silicate, aluminum hydroxide, zeolite, calcined clay, kaolin clay, talc, white carbon, zinc oxide, aluminum oxide, titanium dioxide and barium sulfate, and organic pigments such as styrene resin filler, nylon resin filler, urea formalin resin filler and raw starch particles.

In addition to the above binders, synthetic rubber latexes and synthetic resin emulsions are also usable. For example, styrene-butadiene rubber latex, acrylonitrile-butadiene rubber latex, methyl acrylate-butadiene rubber latex, and polyvinyl acetate emulsion are exemplified.

The binder content of the protective layer is preferably from 10 to 500% by weight, more preferably from 50 to 400% by weight of the pigment in the layer.

For the purpose of further improving water resistance, it is effective to use a cross-linking agent in combination with a catalyst for promoting its reaction. Examples of cross-linking agents include epoxy compounds, blocked isocyanates, vinyl sulfone compounds, aldehyde compounds, methylol compounds, boric acid, carboxylic anhydrides, silane compounds, chelating compounds, halides, and the like. The cross-linking agent is preferably one capable of adjusting the pH of the coating solution to 6.0 to 7.5. The catalysts include known acids, metal salts, and the like, preferably those capable of adjusting the pH of the coating solution to 6.0 to 7.5.

Preferable examples of the lubricants include zinc stearate, calcium stearate, paraffin wax, polyethylene wax, and the like.

For formation of a uniform protective layer on the heat-sensitive recording layer, the surfactant is preferably an alkali metal salt based on sulfosuccinic acid, a fluorine-containing surfactant, and the like. Specifically, sodium salts, ammonium salts and like salts of di-(2-ethylhexyl)sulfosuccinic acid, di-(n-hexyl)sulfosuccinic acid, and the like are used.

A coating solution for forming the protective layer (a coating solution for the protective layer) is prepared by mixing the components described above. If necessary, a releasing agent, a wax, a water repellant and the like may be added.

The heat-sensitive recording material of the present invention can be formed by applying the solution for the protective layer by known coating techniques onto the heat-sensitive recording layer formed on the support. The known coating techniques include those using, for example, a bar coater, an air knife coater, a blade coater or a curtain coater.

The amount of the coated protective layer after drying is preferably 0.2 to 7 g/m², more preferably 1 to 4 g/m². If the amount of the dried layer is less than 0.2 g/m², water resistance cannot be maintained in some cases, while if it exceeds 7 g/m², heat sensitivity may be significantly lowered. After the protective layer is formed by coating, calendering may be conducted if necessary.

When plural heat-sensitive recording layers are laminated, it is preferred to provide an intermediate layer among the respective heat-sensitive recording layers. Similarly to the protective layer, the intermediate layer may contain, in addition to various binders, a pigment, a lubricant, a surfactant, a dispersant, a fluorescent brightener, a metal soap, a UV absorber, and the like. As the binder, the same binders as used in the protective layer can be employed.

(Support)

Examples of supports include polyester films such as polyethylene terephthalate and polybutylene terephthalate, cellulose derivative films such as cellulose triacetate film, polyolefin films such as polystyrene film, polypropylene film and polyethylene film, and synthetic polymer films such as polyimide film, polyvinyl chloride film, polyvinylidene chloride film, polyacrylic acid copolymer film and polycarbonate film, as well as paper, synthetic paper, plastic resin-containing paper, and the like.

The support may be used alone or plural supports may be attached to one another.

The plastic resin-containing paper preferably comprises a base paper and a thermoplastic resin-containing layer formed on both sides of the paper or on the side on which at least the heat-sensitive recording layer is to be formed. The support includes (i) a base paper having thermoplastic resin melt-extruded and deposited thereon, (ii) a base paper having a gas barrier layer applied above the layer of thermoplastic resin melt-extruded and deposited on the paper, (iii) a base paper having a plastic film of low oxygen permeability adhered thereon, (iv) a base paper having the layer of thermoplastic resin melt-extruded and deposited on the plastic film adhered on the paper, or (v) a base paper having the layer of thermoplastic resin melt-extruded and deposited thereon and further having a plastic film adhered on the layer.

Examples of thermoplastic resins to be melt-extruded and applied on a base paper include olefin resins, for example, α-olefin homopolymers such as polyethylene and polypropylene, and mixtures thereof, or random copolymers of ethylene and vinyl alcohol. As a preferable polyethylene, LDPE (low-density polyethylene), HDPE (high-density polyethylene), L-LDPE (linear low-density polyethylene) or the like is exemplifed.

The method of laminating a plastic film on a base paper can be selected suitably from known laminating techniques described in “Shin Laminate Kako Binran” (New Handbook of Laminating Technology) (edited by Kako Gijyutsu Kenkyukai), but it is preferable to employ so-called dry lamination, solvent-free dry lamination, dry lamination using an electron beam curing resin or ultraviolet curing resin, or hot dry lamination.

Among the various supports described above, a paper support comprising a base paper laminated with polyethylene on at least one side thereof is preferable, and generally polyethylene is laminated on the surface of the side on which the heat-sensitive recording layer is formed. A paper support comprising a base paper laminated with polyethylene on both sides thereof is more preferable, and lamination is provided on the surface of the side on which the heat-sensitive recording layer is to be formed for the purpose of improving flatness, and on the surface of the other side for the purpose of adjusting curling balance.

The synthetic polymer film described above may have color exhibiting an arbitrary hue, and the methods of coloring the polymer film include (i) a method in which a dye is kneaded with a resin and then formed into a film, and (ii) a method in which a dye is dissolved in a suitable solvent and then the resultant coating solution is coated and dried on a transparent colorless resin film by known coating techniques such as gravure coating, roller coating, wire coating or the like. Particularly, it is preferable to make a film using a method in which a blue dye is kneaded with a polyester resin such as polyethylene terephthalate or polyethylene naphthalene, formed into a film, which is subjected to heat resistance treatment, elongation, and antistatic treatment.

The thickness of the support is preferably 25 to 300 μm, more preferably 50 to 250 μm.

The heat-sensitive recording layer, the protective layer, the light transmittance-adjusting layer and the intermediate layer can be formed on the support by application of coating by known coating techniques such as blade coating, air knife coating, gravure coating, roll coating, spray coating, dip coating, bar coating and the like, followed by drying.

### EXAMPLES

Hereinafter, the present invention is described with reference to the Examples, which however are not intended to limit the present invention. Hereinafter, “parts” and “%” in the Examples refer to “parts by mass” and “% by mass”, respectively.

### Example 1

(Preparation of a Support)

(1) Preparation of a Coating Solution for Undercoat Layer

12.85 parts of acetoacetyl-modified PVA (“GOSEFIMER Z-210”, polymerization degree: 1000, produced by Nippon Synthetic Chemical Industry Co., Ltd.) was added to 87.15 parts of water, and was dissolved at 90° C. or higher with stirring. To 100 parts of the obtained modified PVA water solution were added 2.58 parts of water and 18.9 parts of water-swelling synthetic mica (“SOMASHIF MEB-3”, an 8% dispersion having an aspect ratio of 1000 and an average particle size of 2.0 μm, produced by Coop Chemical Co.), and the resultant mixture was homogeneously mixed. Thereafter, thereto was slowly added 84.9 parts of methanol while stirring, and further added 3.1 parts of an ethylene oxide-type surfactant (1.66% methanol solution), and finally added 0.45 parts of 1N sodium hydroxide to prepare a coating solution for an undercoat layer having a concentration of 6.87%.

(2) Preparation of a Support with Undercoat Layer

Wood pulp consisting of 100 parts of at least one type of LBKP (hardwood kraft pulp) was beaten by a disk refiner to 300 ml Canadian freeness, and to the resultant pulp were addded 0.5 parts of epoxylated behenic acid amide, 1.0 part of anion polyacrylamide, 1.0 part of aluminum sulfate, 0.1 parts of polyamide polyamine epichlorohydrin, and 0.5 parts of cation polyacrylamide, based on the ratio of the absolute dry weight thereof to that of the pulp, and weighed using a Fourdrinier paper machine. The both surfaces of the paper were coated with a polyvinyl alcohol solution containing calcium chloride and water-soluble fluorescent brightener by using a size press machine to produce a base paper having a weight of 114 g/m², and the thickness thereof was adjusted to be 100 μm by calendering process.

The both surfaces of the resulting base paper were subjected to corona discharge treatment and one surface of the resultant paper was coated with polyethylene to a thickness of 36 μm thereon using a melt-extrusion machine to form a resin layer having a mat surface thereon (hereinafter, the surface of the resin layer is referred to as “back”). The surface opposite to the back surface of the base paper on which the resin layer was coated with polyethylene containing 10% of anatase type titanium dioxide and a very small amount of ultramarine blue by using a melt-extruder to a thickness of 50 μm, to form a resin layer having a glossy surface on the front of the base paper as the support (hereinafter, this glossy surface is referred to as “front”) to thus produce a support. After the polyethylene-coated back surface of the paper was subjected to corona discharge treatment, a dispersion of aluminum oxide (“ALUMINA SOL 100”, produced by Nissan Chemical Industries, Ltd.) and silicon dioxide (“SNOWTEX O”, produced by Nissan Chemical Industries, Ltd.) in a ratio of 1:2 (by mass) dispersed in water was applied thereon to achieve a dry weight of 0.2 g/m². After the polyethylene-coated front surface of the paper was subjected to corona discharge treatment, the above-described undercoat-layer coating solution was kept at 40° C. and applied thereon by an oblique line gravure roll (#100 mesh) and dried to form a support with an undercoat layer. The coating amount of the solution before drying was 12.5 g/m².

(Formation of Back Coat Layer)

(1) Preparation of a Coating Solution for the Outermost Back Layer

To 100 parts of a 12.5% water solution of polyvinyl alcohol (“PVA105” produced by Kuraray Co., Ltd.) were added 6 parts of a 2% water solution of 2-ethylhexyl sulfosuccinate (“RAPISOL B-90” produced by NOF Corporation), 33 parts of a synthetic mica dispersion (“SOMASIF MEB-3 (8% dispersion), produced by Coop Chemical Co., Ltd.), and 20 parts of an aluminum hydroxide dispersion liquid (wherein 100 parts of “HIGILITE H42S” produced by Showa Light Metal Co., Ltd., 1 part of sodium hexametaphosphate, and 150 parts of water were mixed and dispersed so as to have an average particle size of 0.5 μm using a ball mill), and the mixture was stirred, thereby obtaining a coating solution for the outermost back layer containing the synthetic mica, aluminum hydroxide and polyvinyl alcohol.

(2) Preparation of Coating Solution for Intermediate Back Layer

300 parts of 15% water lime-processed gelatin solution, 100 parts of 2% di-2-ethylhexyl sulfosuccinate solution (“RAPISOL B-90” produced by NOF Corporation) and 1800 parts of water were admixed to give a coating solution for the intermediate back layer.

(3) Formation of the Back Coat Layer

The coating solution for the intermediate back layer and the coating solution for the outermost back layer were applied in this order onto the surface (back) of the support in amounts to give 9.5 g/m² and 2.2 g/m² in dry weights, respectively, followed by drying to form a back coat layer consisting of two layers, i.e., the intermediate back layer and the outermost back layer on the support.

(Preparation of Water Lime-Processed Gelatin Solution)

25.5 parts of lime-processed low-ion content gelatin (“#750 GELATIN”, produced by Nitta Gelatin), 0.7286 parts of 1,2-benzothiazolin-3-one (3.5% solution in methanol, produced by Daito Chemical Industry), 0.153 parts of calcium hydroxide, and 116 parts of ion exchange water were mixed and dissolved at 50° C. to obtain a water gelatin solution for preparing an emulsion.

(Preparation of Water Solution of Phthalated Gelatin)

32 parts by weight of phthalated gelatin (“#801 GELATIN”, produced by Nitta Gelatin Inc.), 0.9143 parts by weight of 1,2-benzothiazolin-3-one (3.5% solution in methanol, produced by Daito Chemical Industry), and 367.1 parts by weight of ion exchange water were mixed and dissolved at 40° C. to prepare a water solution of phthalated gelatin.

(Preparation of Coating Solution for Cyan Color-Forming Heat-Sensitive Recording Layer)

(1) Preparation of Solution (A) Containing Microcapsules Encapsulated an Electron-Donating Dye Precursor Therein

To 18.1 parts of ethyl acetate were added 7.6 parts of the following electron-donating dye precursor (1), 6.0 parts of trimethylolpropane trimethacrylate (trade name: LIGHT ESTER TMP, produced by Kyoeisha Yushi Kagaku Co., Ltd.), 6.0 parts of diisopropylnaphthalene (trade name: KMC113, produced by Kureha Chemical Industry Co., Ltd.), and 4.0 parts of 1,1,3-tris(2-methyl-4-hydroxy-5-t-butylphenyl)butane (trade name: ADEKACRUISE DH-37, produced by Asahi Denka Kogyo K.K.). The mixture was heated and made into a homogeneous solution. To the mixed solution thus obtained were added 7.1 parts of xylylene diisocyanate/trimethylol propane adduct (trade name: TAKENATE D110N, a 75% ethyl acetate solution, produced by Mitsui Takeda Chemical Co., Ltd.), 5.3 parts of polymethylenepolyphenyl polyisocyanate (trade name: MILLIONATE MR-200, produced by Nippon Polyurethane Industry Co., Ltd.), and 3.1 parts of xylylene diisocyanate/compound (2) adduct (a 50% ethyl acetate solution) as capsule wall forming materials, and the mixture was homogeneously mixed to prepare solution (a).

Separately, to 57.6 parts of the water phthalated gelatin solution described above were added 9.5 parts of ion exchange water, 0.17 parts of “SCRAPH AG-8” (50% solution, produced by Nippon Seika Co., Ltd.), and 4.3 parts of sodium dodecylbenzenesulfonate (10% water solution, and homogeneously mixed to give solution (b).

The solution (a) was added to the solution (b) and the resulting mixture was subjected to emulsifying dispersion by a homogenizer (produced by Nippon Seiki Seisakusho Co., Ltd.) at 40° C. Then, 21.2 parts of water and 0.12 parts of tetraethylenepentamine were added to the emulsified dispersion liquid thus obtained and the resultant solution was homogeneously mixed. Then, an encapsulation reaction was carried out by stirring the solution at 65° C. over 3 hours while removing the ethyl acetate. Thereafter, the concentration of the solution containing microcapsules was adjusted so that the concentration of the solid components became 33%. The median particle diameter of the microcapsules obtained was found to be 0.93 μm as a result of measurement using a particle size meter (trade name: LA-700, produced by Horiba Ltd.).

Further, to 100 parts of the above-described solution containing microcapsules were added 3.7 parts of a 25% water solution of sodium dodecylbenezenesulfonate (trade name: NEOPELEX F-25, produced by Kao Corporation) and 1.5 parts of 4,4′-bistriazinylaminostilbene-2,2′-disulfone derivative (trade name: KAYCOLL BXNL, produced by Nippon Soda Co., Ltd.), and the resulting mixture was homogeneously mixed. As a result, a solution (A) containing microcapsules encapsulated an electron-donating dye precursor therein was obtained. 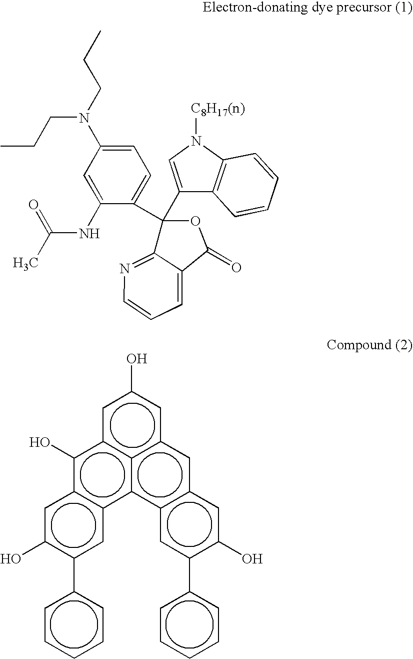
(2) Preparation of Emulsified Dispersion (B) of Electron-Accepting Compound

To 8.5 parts of the above-described water solution of phthalated gelatin and 11.3 parts of “PGLE ML10” (6% water solution, produced by Daicel Chemical Industries, Ltd.) were added 30.1 parts of ion exchange water, 7.5 parts of 4,4′-(p-phenylenediisopropylidene) diphenol (trade name: BISPHENOL P, produced by Mitsui Petrochemical Co., Ltd.), 7.5 parts of 1,1-bis(4-hydroxyphenyl)-1-phenylethane (trade name: BISP-AP, produced by Honsyu Kagaku), 3.8 parts of a 2% water solution of sodium 1-ethylhexyl succinate, and 1.0 part of “DEMOL NL” (2% solution, produced by Kao Corporation), and the resulting mixture was dispersed overnight in a ball mill. The dispersion solution thus obtained had a concentration of solid components of 26.6%.

To 100 parts of the dispersion solution was added 31.6 parts of the water alkali-treated gelatin solution described above and the resulting mixture was stirred for 30 minutes. Thereafter, the concentration of solid components of the dispersion solution was adjusted so as to be 23.5% by the addition of ion exchange water. In this way, an emulsified dispersion solution (B) containing an electron-accepting dye compound was obtained. The median particle diameter of the dispersion solution (B) thus obtained was found to be 0.78 μm as a result of measurement using a particle size meter (trade name: LA-700, produced by Horiba Ltd.).

(3) Preparation of Coating Solution for Heat-Sensitive Recording Layer

The solution (A) containing microcapsules enclosing an electron-donating dye precursor and the emulsified dispersion solution (B) of an electron-accepting compound were mixed together such that the weight ratio of the electron-accepting compound/the electron-donating dye precursor became 10/1. In this way, an intended coating solution for a cyan heat-sensitive recording layer was obtained.

(Preparation of Coating Solution for Magenta Color-Forming Heat-Sensitive Recording Layer)

(1) Preparation of Solution (C) Containing Microcapsules Encapsulating Diazonium Salt

To 12.8 parts of ethyl acetate were added 3.8 parts of the diazonium salt compound (3) described below (maximum absorption wavelength: 365 nm), 7.6 parts of isopropyl bephenyl, 2.0 parts of tricresyl phosphate, 1.1 parts of dibutyl sulfate, 0.38 parts of ethyl (2,4,6-trimethylbenzoyl) phenylphosphinate (trade name: LUCIRIN TPO-L, produced by BASF Japan Ltd.), and 0.10 parts of calcium dodecylbenzenesulfonate (trade name: PIONIN A-41-C (70% methanol solution), produced by Takemoto Oil & Fat Co., Ltd.), and the mixture was heated and dissolved homogeneously.

To the mixed solution thus obtained was added 10.9 parts of xylylene diisocyanate/trimethylol propane adduct (trade name: TAKENATE D110N (75% ethyl acetate solution), produced by Mitsui Takeda Chemical Co., Ltd.) as capsule wall forming material, and the mixture was homogeneously stirred to obtain a solution (c).

Separately, to 59.9 parts of the above-described water phthalated gelatin solution were added 22.8 parts of ion exchange water and 0.31 parts of sodium dodecylbenzenesulfonate (trade name: NEOPELEX F-25 (25% water solution), produced by Kao Corporation), and the mixture was homogenized to obtain a solution (d).

The solution (c) was added to the solution (d) and the resulting mixture was subjected to emulsifying dispersion using a homogenizer (produced by Nippon Seiki Seisakusho Co., Ltd.) at 30° C. To the emulsified dispersion solution thus obtained was added 29.1 parts of water, and the mixed solution was homogenized. Thereafter, an encapsulation reaction was carried out by stirring the solution at 40° C. over 2 hours while removing the ethyl acetate. Subsequently, thereto were added 1.16 parts of an ion exchange resin (trade name: AMBERLITE IRA67, produced by Organo Corporation) and 2.33 parts of “SWA 100-HG” (produced by Organo Corporation), and further the mixture was stirred for 20 minutes. Next, the ion exchange resin was filtrated to be removed. The concentration of the capsule solution was adjusted so that the solid components became 18.5%. In this way, a solution (c) containing microcapsules encapsulated a diazonium salt therein was obtained. The particle size of the resultant microcapsules was measured using a particle size meter (trade name: LA-700, produced by Horiba Ltd.). As a result, the median size thereof was 0.44 μm. 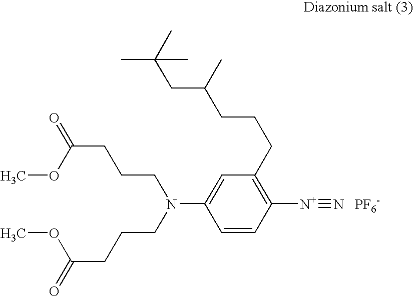
(2) Preparation of Coupler-Emulsified Dispersion (D)

Into 15.0 parts of ethyl acetate were dissolved 6.3 parts of the following coupler compound (4), 14.0 parts of triphenylguanidine (produced by Hodogaya Chemical Co., Ltd.), 14.0 parts of 4,4′-(m-phenylenediisopropylidene) diphenol (trade name: BISPHENOL M, produced by Mitsui Petrochemical Co., Ltd.), 14 parts of 1,1-(p-hydroxyphenyl)-2-ethylhexane, 3.5 parts of 3,3,3′,3′-tetramethyl-5,5′,6,6′-tetra(1-propyloxy)-1-1′-spirobisindane, 3.5 parts of the following compound (5), 1.7 parts of tricresyl phosphate, 0.8 parts of diethyl maleate, and 4.5 parts of calcium dodecylbenzenesulfonate (trade name: PIONIN A-41-C (70% methanol solution), produced by Takemoto Oil & Fat Co., Ltd.) to obtain a mixed solution (e).

The mixed solution (e) thus obtained was added to 173 parts of the above-described water lime-processed gelatin solution and the resulting mixture was subjected to emulsifying dispersion by a homogenizer (produced by Nippon Seiki Seisakusho Co., Ltd.) at 40° C. To the coupler-emulsified dispersion thus obtained was added 139 parts of ion exchange water, and the mixture was homogenized and heated while reducing the pressure to thereby remove ethyl acetate. Thereafter, the solid concentration therein was adjusted so as to be 24.5%. In this way, a coupler-emulsified dispersion (D) was obtained. The particle size of the resultant coupler-dispersed emulsion (D) was measured using a particle size meter (trade name: LA-700, produced by Horiba Ltd.). As a result, the median size thereof was 0.13 μm. 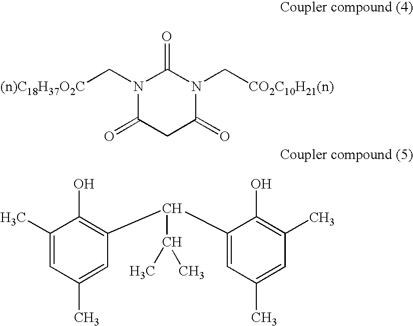
(3) Preparation of Coating Solution for Heat-Sensitive Recording Layer

The solution (C) containing microcapsules enclosing a diazonium salt and the coupler-emulsified dispersion (D) were mixed such that the weight ratio of the coupler compound/the diazonium salt became 1.9/1. Further, to the mixed solution was added 0.15 parts of polystyrene sulfonate (partially neutralized potassium hydroxide) to 10 parts of the solution (C) containing microcapsules enclosing a diazonium salt. In this way, an intended coating solution for a magenta color-forming heat-sensitive recording layer was obtained.

(Preparation of Coating Solution for Yellow Color-Forming Heat-Sensitive Recording Layer)

(1) Preparation of Solution (E) Containing Microcapsules Encapsulating a Diazonium Salt

To 16.1 parts of ethyl acetate were added 1.1 parts of the following diazonium salt compound (6) (maximum absorption wavelength: 420 nm), 3.3 parts of the following diazonium salt compound (7) (maximum absorption wavelength: 420 nm), 10.4 parts of monoisopropyl biphenyl, 1.7 parts of diphenyl phthalate, 1.7 parts of phenyl 2-benzoyloxy benzoate, and 0.4 parts of diphenyl-(2,4,6-trimethylbenzoyl)phosphineoxide (trade name: LUCIRIN TPO, produced by BASF Japan Ltd.), and heated at 40° C. and homogenized. To the mixed solution were added 3.1 parts of xylylene diisocynate/trimethylol propane adduct (trade name: TAKENATE D110N (75% ethyl acetate solution), produced by Mitsui Takeda Chemical Co., Ltd.) and 4.8 parts of a mixture of a xylylene diisocynage/trimethylol propane adduct and a xylylene diisocynage/bisphenol A adduct (trade name: TAKENATE D119N, a 50% ethyl acetate water solution, produced by Mitsui Takeda Chemical Co., Ltd.) as capsule wall forming material, and homogeneously stirred to produce a solution (g).

Separately, 11.5 parts of ion exchange water and 0.35 parts of “SCRAPH AG-8” (a 50% solution, produced by Nippon Fine Chemical Co., Ltd.) were added to 59.7 parts of the above-described water phthalated gelatin solution, to produce a mixed solution (h).

The mixed solution (g) was added to the mixed solution (h), and the mixed solution was emulsified and dispersed using a homogenizer (produced by Nippon Seiki Seisakusho Co., Ltd.) at 40° C. To the resultant emulsified dispersion were added 23 parts of water, and the mixture was homogenized. The resultant solution was then stirred at 40° C. to conduct an encapsulating reaction for 3 hours while removing ethyl acetate. Thereafter, there to were added 0.34 parts of 1,2-benzothiazoline-3-one (a 3.5% solution in methanol, produced by Daito Chemix Corporation), 4.1 parts of an ion exchange resin (trade name: AMBERLITE SWA100-HG, produced by Organo Corporation), and 5.8 parts of an ion exchange resin (trade name: Amberlite IRA67, produced by ROHM AND HAAS (UK) LIMITED), and further the mixture was stirred for one and a half hours. Subsequently, the ion exchange resins were filtrated to be removed. The solid concentration of the capsule solution was adjusted so as to be 20%. In this way, a diazonium salt compound encapsulated microcapsule solution (E) was obtained. The particle size of the resultant microcapsules was measured with a particle size meter (trade name: LA-700, produced by Horiba Ltd.). As a result, the median size thereof was 0.36 μm. 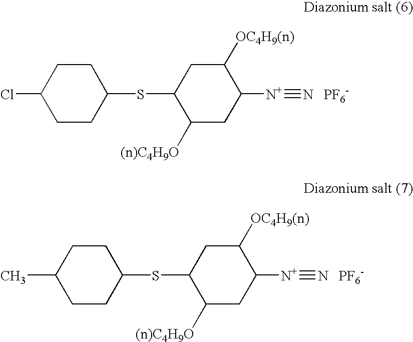
(2) Preparation of Coupler-Emulsified Dispersion (F)

Into 23.0 parts of ethyl acetate were dissolved 9.9 parts of the following coupler compound (8), 9.9 parts of triphenylguanidine (produced by Hodogaya Chemical Co., Ltd.), 20.8 parts of 4,4′-(m-phenylenediisopropylidene) diphenol (trade name: BISPHENOL M, produced by Mitsui Petrochemical Co., Ltd.), 3.3 parts of 3,3,3′,3″-tetramethyl-5,5′,6,6′-tetra(1-propyloxy)-1,1′-spirobisindance, 13.6 parts of 4-(2-ethylhexyloxy) benzenesulfonamide (produced by Manac Inc.), 6.8 parts of 4-n-pentyloxybenzenesulfonamide (produced by Manac Inc.), and 4.2 parts of calcium dodecylbenzenesulfonate (trade name: PIONIN A-41-C (70% methanol solution) produced by Takemoto Oil & Fat Co., Ltd.) to produce a mixed solution (i).

The above-described solution (i) was added to 173 parts of the above-described water lime-processed gelatin solution, and the mixed solution was emulsified and dispersed using a homogenizer (produced by Nippon Seiki Seisakusho Co., Ltd.) at 40° C. Added to the resultant coupler-emulsified dispersion was 139 parts of ion exchange water, and homogeneously mixed, and thereafter, was heated under reduced pressure to remove ethyl acetate. Subsequently, the solid concentration of the solution was adjusted so as to be 26.5%. The particle size of the resultant coupler-emulsified dispersion was measured with a particle size meter (trade name: LA-700, produced by Horiba Ltd.). As a result, the median size thereof was 0.16 μm.

Further, to 100 parts of the coupler-emulsified dispersion was added 9 parts of a solution in which the concentration of an SBR latex (trade name: SN-307 (48% solution), produced by Sumika ABS Latex Co., Ltd.) was adjusted so as to be 26.5%, and then the mixture was homogeneously stirred to produce a coupler-emulsified dispersion (F). 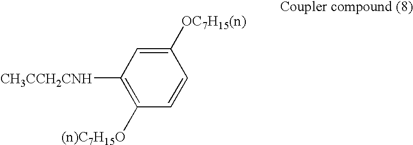
(3) Preparation of Coating Solution for Heat-Sensitive Recording Layer

The diazonium salt compound encapsulated microcapsule solution (E) and the coupler-emulsified dispersion (F) were mixed in such a manner that the weight ratio between the coupler compound and diazonium salt would be 2.2/1, to obtain an intended coating solution for a yellow color-forming heat-sensitive recording layer.

(Preparation of Coating Solution for Intermediate Layer)

100 parts of lime-processed low-ion content gelatin (trade name: #750 gelatin, produced by Nitta Gelatin Inc.), 4.8 parts of 1,2-benzothiazoline-3-one (a 3.5% solution in methanol, produced by Daito Chemix Corporation), 0.3 parts of calcium hydroxide, 6.9 parts of boric acid, and 520 parts of ion exchange water were mixed, and dissolved at 50° C. to produce a water gelatin solution for forming an intermediate layer.

100 parts of the above-described intermediate layer forming water gelatin solution, 0.5 parts of sodium (4-nonylphenoxytrioxyethylene) butylsulfonate (2.0% water solution, produced by Sankyo Chemical Co., Ltd.), 0.6 parts of a water polystyrenesulfonic acid (partially neutralized with potassium hydroxide) solution (5% by mass), 10 parts of the following compound (9) (4% water solution, produced by Wako Pure Chemicals Industries), 3.3 parts of the following compound (10) (4% water solution, produced by Wako Pure Chemicals Industries), and 23 parts of ion exchange water were mixed. In this way, a coating solution for an intermediate layer was obtained.
CH₂CHSO₂CH₂CONHCH₂CH₂NHCOCH₂SO₂CH═CH₂ Compound (9)
CH₂═CHSO₂CH₂CONHCH₂CH₂CH₂NHCOCH₂SO₂CH═CH₂ Compound (10)
(Preparation of Coating Solution for Light Transmittance Adjusting Layer)
(1) Preparation of Microcapsule Solution Containing Ultraviolet Absorber Precursor

Into 209 parts of ethyl acetate were homogeneously dissolved 36.9 parts of [2-allyl-6-(2H-benzotriazole-2-yl)-4-t-octylphenyl] benzenesulfonate as an ultraviolet absorber precursor, 12.7 parts of 2,2′-t-octylhydroquinone, 4.8 parts of tricresyl phosphate, 15.1 parts of α-methylstyrene dimer (trade name: MSD-100, produced by Mitsui Chemicals, Inc.), 1.3 parts of calcium dodecylbenzenesulfonate (trade name: PIONIN A-41-C (70% methanol solution), produced by Takemoto Oil & Fat Co., Ltd.). To the mixed solution was added 74.5 parts of xylylenediisocyanate/trimethylolpropane adduct (trade name: TAKENATE D110N (75% ethyl acetate solution), produced by Mitsui Takeda Chemicals, Inc.) as capsule wall material, and the mixture was homogeneously stirred to produce an ultraviolet absorber precursor mixed solution.

Separately, 14.1 parts of a 30% water solution of phosphoric acid, and 1685 parts of ion exchange water were mixed with 83.4 parts of itaconic acid modified polyvinyl alcohol (trade name: KL-318, produced by Kuraray Co., Ltd.) and also with 46.9 parts of silica modified polyvinyl alcohol (trade name: R-1130, saponification degree: 98% (10% water solution) produced by Kuraray Co., Ltd.). In this way, a water PVA solution for an ultraviolet absorber precursor microcapsule solution was prepared.

To 1530 parts of the above-described water PVA solution for an ultraviolet absorber precursor microcapsule solution was added the ultraviolet absorber precursor mixed solution, and the resultant solution was emulsified and dispersed using a homogenizer (produced by Nippon Seiki Seisakusho Co., Ltd.) at 20° C. To the resultant emulsified dispersion were added 300 parts of ion exchange water, and the mixture was homogenized. Thereafter, the resultant mixture was stirred at 40° C. to conduct encapsulating reaction for 3 hours. Subsequently, thereto was added 830 parts of an ion exchange resin (trade name: AMBERLITE MB-3, produced by Organo Corporation) and further the mixture was stirred for one hour. Thereafter, the ion exchange resin was filtrated to be removed. The concentration of the microcapsule solution was adjusted so that the concentration of the solid components became 13%. The particle size of the resultant microcapsules was meausred with a particle size meter (trade name: LA-700, produced by Horiba Ltd.). As a result, the median size thereof was 0.23±0.05 μm.

To 1244 parts of this capsule solution were added 20.6 parts of colloidal silica (trade name: SNOWTEX OL, a 20% water solution, produced by Nissan Chemical Industries, Ltd.) and 3.4 parts of a carboxy modified styrene/butadiene latex (trade name: SN-307 (48% water solution), produced by Sumitomo Naugatuck Co., Ltd.) to obtain an ultraviolet absorber precursor microcapsule solution.

(2) Preparation of Coating Solution for Light Transmittance Adjusting Layer

1000 parts of the above-described ultraviolet absorber precursor microcapsule solution, 15.0 parts of a 4% water solution of sodium hydroxide, and 51.36 parts of sodium (4-nonylphenoxytrioxyethylene) butylsulfonate (2.0% water solution), produced by Sankyo Chemical Co., Ltd.) were mixed and homogenized, to obtain a coating solution for a light transmittance adjusting layer.

(Preparation of Coating Solution for Protective Layer)

(1) Preparation of Polyvinyl Alcohol Solution for Protective Layer

1500 parts of vinyl alcohol-alkyl vinyl ether copolymer (trade name: EP-130, produced by Denki Kagaku Kogyo Kabushiki Kaisha), 7.5 parts of a mixed solution of sodium alkylsulfonate and a polyoxyethylene alkyl ether phosphate (trade name: NEOSCORE CM-57 (54% water solution), produced by Toho Chemical Industry Co., Ltd.), 7.05 parts of ethylene oxide adduct of acetylene diol (trade name: DYNOL 604, produced by Air Products Japan, Inc.), 7.05 parts of silicon type surfactant (trade name: SYLGARD 309, produced by TORAY DOWCORNING SILICONE), and 3592 parts of ion exchange water were mixed, and the mixture was dissolved at 90° C. for one hour. In this way, a homogeneous polyvinyl alcohol solution for a protective layer was obtained.

(2) Preparation of Pigment Dispersed Solution for Protective Layer

0.2 parts of an anionic special carboxylic acid type polymer surfactant (trade name: POISE 532A (40% water solution), produced by Kao Corporation) and 11.8 parts of ion exchange water were mixed with 8 parts of barium sulfate (trade name: BF-21, having a barium sulfate content of 93% or more and produced by Sakai Chemical Industry Co., Ltd.), and the mixture was dispersed in a Dyno mill to prepare a pigment dispersed solution for a protective layer. The particle size of this dispersed solution was measured with a particle size meter (trade name: LA-910, produced by Horiba Ltd.). As a result, the median size thereof was 0.15 μm.

To 1000 parts of the above-described barium sulfate dispersed solution were added 3.06 parts of a water dispersion of 1,2-benzthiazoline-3-one (trade name: PROXEL B.D., produced by I.C.I. Co., Ltd.”, 36.4 parts of wheat starch (trade name: WHEAT STARCH S, produced by Shinshin Shokuryo Kogyo), 181 parts of colloidal silica (trade name: SNOWTEX 0 (20% water dispersion solution), produced by Nissan Chemical Industries, Ltd.), and 67.7 parts of acrylic silicone modified resin emulsion (trade name: ARJ-2A (44% dispersion), produced by Nippon Junyaku Co., Ltd.) while stirring, to thereby produce a pigment dispersion for a protective layer.

(3) Preparation of Coating Blend Solution for Protective Layer

To 1000 parts of the above-described PVA solution for a protective layer were added 90.4 parts of ion exchange water, 49.4 parts of sodium (4-nonylphenoxytrioxyethylene) butylsulfonate (2.0% water solution), produced by Sankyo Chemical Co., Ltd.), 87.6 parts of the above-described pigment dispersion for a protective layer, 48.2 parts of a zinc stearate dispersion (trade name: HI-MICRON F111 (21% water solution), produced by Chukyo Yushi Co., Ltd.), 153.9 parts of a 4% water solution of the above-described compound (9) (produced by Wako Pure Chemicals Industries), and 51.3 parts of a 4% water solution of the above-described compound (10) (produced by Wako Pure Chemicals Industries), and the mixture was homogeneously mixed. As a result, a coating blend solution for a protective layer was obtained.

(Preparation of Heat-Sensitive Recording Material)

The coating solution for a cyan color-forming heat-sensitive recording layer, the coating solution for an intermediate layer, the coating solution for a magenta color-forming heat-sensitive recording layer, the coating solution for an intermediate layer, the coating solution for a yellow color-forming heat-sensitive recording layer, the coating solution for a light transmittance adjusting layer, and the coating layer for a protective layer were applied, in this order, onto the substrate coated with the under coat layer at the same time. The applied solutions were sufficiently dried to obtain a multicolor heat-sensitive recording material.

At this time, the coating amounts of these solutions in terms of solid component after drying were 7.3 g/m² (in the cyan color-forming heat-sensitive recording layer), 3.3 g/m² (in the intermediate layer), 7.7 g/m² (in the magenta color-forming heat-sensitive recording layer), 2.5 g/m² (in the intermediate layer), 4.6 g/m² (in the yellow color-forming heat-sensitive recording layer), 2.4 g/m² (in the light transmittance adjusting layer), and 1.9 g/m² (in the protective layer), respectively.

### Examples 2 to 6

Multicolor heat-sensitive recording materials of Examples 2 to 6 were prepared in the same manner as in Example 1 except that, in the preparation of the coupler emulsified dispersion for a magenta color-forming heat-sensitive recording layer, and/or in the preparation of the coupler emulsified dispersion for a yellow color-forming heat-sensitive recording layer, the particle size of the above-described emulsified dispersion was changed by adjusting the amount of ethyl acetate used, the gelatin concentration of a water phase solution, the rotational frequency of the homogenizer, and the like. Further, in order to adjust the particle size of microcapsules of the microcapsule solution encapsulating diazoninum salt or electron-donating dye precursor, the time for emulsifying dispersion was changed and an intended capsule solution was obtained. The particle size of the microcapsules, and the particle size ratio of the emulsified dispersion/the coupler compound (E/C) are shown in Tables 1A and 1B below. In Tables 1A and 1B shown below, the amount of each color forming layer applied (solid content) is indicated as a value relative to the amount of coating in Example 1.

### Comparative Examples 1 to 3

Multicolor heat-sensitive recording materials of Comparative Examples 1 to 3 having the respective emulsion particle sizes and coating amounts shown in Tables 1A and 1B below were prepared in the same manner as in Examples 2 to 6.

TABLE 1A

| | Magenta Color-Forming Layer | | | |
|---|---|---|---|---|
| | Emulsion | capsule particle | (E/C) particle | amount of |
| | particle size | size | size ratio | coating |
| Example 1 | 0.13 μm | 0.44 μm | 0.30 | (1.0) |
| Example 2 | 0.16 | 0.43 | 0.37 | 1.0 |
| Example 3 | 0.09 | 0.43 | 0.21 | 1.0 |
| Example 4 | 0.12 | 0.40 | 0.30 | 1.0 |
| Example 5 | 0.09 | 0.40 | 0.23 | 0.75 |
| Example 6 | 0.13 | 0.42 | 0.31 | 0.80 |
| Comparative | 0.25 | 0.44 | 0.57 | 1.0 |
| Example 1 | | | | |
| Comparative | 0.25 | 0.40 | 0.63 | 1.0 |
| Example 2 | | | | |
| Comparative | 0.25 | 0.40 | 0.63 | 0.75 |
| Example 3 | | | | |

TABLE 1B

| | Yellow Color-Forming Layer | | | |
|---|---|---|---|---|
| | Emulsion | capsule particle | (E/C) particle | amount of |
| | particle size | size | size ratio | coating |
| Example 1 | 0.16 μm | 0.36 μm | 0.44 | (1.0) |
| Example 2 | 0.15 | 0.38 | 0.39 | 1.0 |
| Example 3 | 0.13 | 0.36 | 0.36 | 1.0 |
| Example 4 | 0.11 | 0.33 | 0.33 | 1.0 |
| Example 5 | 0.13 | 0.33 | 0.39 | 0.85 |
| Example 6 | 0.11 | 0.33 | 0.33 | 0.75 |
| Comparative | 0.23 | 0.36 | 0.64 | 1.0 |
| Example 1 | | | | |
| Comparative | 0.23 | 0.33 | 0.70 | 1.0 |
| Example 2 | | | | |
| Comparative | 0.23 | 0.33 | 0.70 | 0.80 |
| Example 3 | | | | |

(Evaluation of Heat-Sensitive Recording Materials)

Each of the heat-sensitive recording materials of Examples 1 to 6 and Comparative Examples 1 to 3 thus obtained was evaluated in terms of magenta/yellow color density of an image portion, and color reproducibility and sharpness of a recorded image were sensorially evaluated by the following methods. The results are shown in table 2 shown below.

(1) Evaluation of Color-Forming Property

Single-color printing for yellow, magenta and cyan was carried out using a digital printer (trade name: NC370D, produced by Fuji Photo Film Co., Ltd.) for each of the above-described heat-sensitive recording materials. Next, the color density of each of print samples was measured using a blue filter, a green filter, and a red filter in an optical densitometer (trade name: MODEL 310, produced by X-rite).

The evaluation results of the color forming property are indicated as a single-color density ratio of each sample at a printing energy which was set so that each single-color density of Comparative Example 1 became 1.0.

(2) Evaluations of Color Reproducibility and Sharpness

Further, the color reproducibility and sharpness were evaluated by the following methods.

An image obtained by photographing a cloth colored in light yellow, blue, pink, green, red and the like, and flowers or a landscape, was printed on the respective heat-sensitive recording materials using the above-described printer. At this time, the printing energy was adjusted for each heat-sensitive recording material so as to obtain in advance optimum color balance. The images thus obtained were each subjected to sensory evaluation of image quality on the color reproducibility, sharpness and the like.

TABLE 2

| | magenta color | yellow color | color reproducibility, |
|---|---|---|---|
| | density (relative | density | sharpness (sensory |
| | value) | (relative value) | evaluation) |
| Example 1 | 1.18 | 1.14 | less color impurity, |
| | | | high image density |
| | | | and high sharpness |
| Example 2 | 1.15 | 1.08 | same as above |
| Example 3 | 1.21 | 1.16 | same as above |
| Example 4 | 1.23 | 1.25 | same as above |
| Example 5 | 1.02 | 1.07 | Sharp human eye |
| | | | image and hair image, |
| | | | and sense of clarity of |
| | | | subtle color (e.g., blue |
| | | | or green) were |
| | | | excellent |
| Example 6 | 1.02 | 1.03 | same as above |
| Example 7 | 1.15 | 1.13 | less color impurity, |
| | | | high image density |
| | | | and high sharpness |
| Comparative | (1.0) | (1.0) | (comparison sample) |
| Example 1 | | | |
| Comparative | 1.02 | 1.03 | (comparison sample) |
| Example 2 | | | |
| Comparative | 1.02 | 1.03 | (comparison sample) |
| Example 3 | | | |

The results shown in Table 2 demonstrate that the heat-sensitive recording materials of the present invention each having a heat-sensitive recording layer in which an electron-accepting compound or a coupler compound is contained as an emulsified dispersion having a volume average particle size of less than 0.18 μm had high color densities of magenta and yellow, and excellent color reproducibility and sharpness, as compared with the heat-sensitive recording materials of the comparative examples.

1. A heat-sensitive recording material in which heat-sensitive recording layers are provided on a support, the heat-sensitive recording layers containing, as an emulsified dispersion, an electron-accepting compound which reacts with an electron-donating dye precursor to form color, or a coupler compound which reacts with a diazonium salt to form color,
wherein at least one layer of the heat-sensitive recording layers contains the emulsified dispersion having a volume average particle size of less than 0.18 μm.

2. The heat-sensitive recording material of claim 1, wherein the volume average particle size is 0.16 μm or less.

3. The heat-sensitive recording material of claim 1, comprising at least three heat-sensitive recording layers, which form colors of yellow, magenta and cyan, respectively, wherein at least one of the three layers contains the emulsified dispersion having a volume average particle size of less than 0.18 μm.

4. The heat-sensitive recording material of claim 2, comprising at least three heat-sensitive recording layers, which form colors of yellow, magenta and cyan, respectively, wherein at least one of the three layers contains the emulsified dispersion having a volume average particle size of less than 0.16 μm.

5. The heat-sensitive recording material of claim 1, wherein in at least one layer of the heat-sensitive recording layers the electron-donating dye precursor or the diazonium salt are encapsulated in microcapsules, and the volume average particle size of the emulsified dispersion is less than 0.5 relative to the volume average particle size of the microcapsules.

6. The heat-sensitive recording material of claim 2, wherein in at least one layer of the heat-sensitive recording layers the electron-donating dye precursor or the diazonium salt are encapsulated in microcapsules, and the volume average particle size of the emulsified dispersion is less than 0.5 relative to the volume average particle size of the microcapsules.

7. The heat-sensitive recording material of claim 3, wherein in at least one layer of the heat-sensitive recording layers the electron-donating dye precursor or the diazonium salt are encapsulated in microcapsules, and the volume average particle size of the emulsified dispersion is less than 0.5 relative to the volume average particle size of the microcapsules.

8. The heat-sensitive recording material of claim 4, wherein in at least one layer of the heat-sensitive recording layers the electron-donating dye precursor or the diazonium salt are encapsulated in microcapsules, and the volume average particle size of the emulsified dispersion is less than 0.5 relative to the volume average particle size of the microcapsules.
